(19) United States
(12) Patent Application Publication
(10) Pub. No.: US 2025/0073891 A1
(43) Pub. Date: Mar. 6, 2025

(54) TRUNK SUPPORT EXOSKELETON WITH ONE POWERED ACTUATOR

(71) Applicants: The Regents of the University of California, Oakland, CA (US); suitX, Inc., Emeryville, CA (US)

(72) Inventors: Wayne TUNG, Emeryville, CA (US); Homayoon KAZEROONI, Oakland, CA (US); Jing-Song HUANG, Emeryville, CA (US); Yi ZENG, Emeryville, CA (US); Zhendong LIU, Emeryville, CA (US)

(73) Assignees: The Regents of the University of California, Oakland, CA (US); suitX, Inc., Emeryville, CA (US)

(21) Appl. No.: 18/913,164

(22) Filed: Oct. 11, 2024

Related U.S. Application Data
(63) Continuation-in-part of application No. 18/854,714, filed on Jan. 1, 0001.
(60) Provisional application No. 63/362,778, filed on Apr. 11, 2022.
(60) Provisional application No. 63/362,779, filed on Apr. 11, 2022.

(51) Int. Cl. B25J 9/00; B25J 9/10; B25J 9/12; B25J 13/08

(52) U.S. Cl. CPC B25J 9/0006; B25J 9/102; B25J 9/1045; B25J 9/126; B25J 13/088

(57) ABSTRACT

A trunk-supporting exoskeleton for reducing muscle forces in a wearer's back during forward lumbar flexion comprises a supporting trunk, a first thigh link, a second thigh link, and an actuator, which includes an actuator first element and an actuator second element. When the wearer is in a forward-bent position, the actuator generates a first torque on the actuator first element and a second actuator torque on the actuator second element to generate extension torques between the first and second thigh links and the supporting trunk, thereby resisting bending motion of the supporting trunk in the forward-bent position. When the wearer is not in the forward-bent position, the actuator generates a substantially small first torque and second torque, resulting in small resistance to the movement of the thigh links relative to the supporting trunk during walking.

### CROSS-REFERENCE TO RELATED APPLICATIONS

This application is a continuation-in-part of U.S. application Ser. No. 18/854,714, filed Oct. 7, 2024, which is a US national stage entry application from International Application No. PCT/US2023/018217, filed Apr. 11, 2023, which claims the benefit of U.S. Provisional Patent Application No. 63/362,778, filed Apr. 11, 2022, and U.S. Provisional Patent Application No. 63/362,779, filed Apr. 11, 2022. Each of these applications is incorporated herein by reference in its entirety.

International Application No. PCT/US2023/018163 entitled “AN ACTUATOR FOR AN EXOSKELETON,” filed Apr. 11, 2023 is incorporated herein in its entirety by reference thereto.

### TECHNICAL FIELD

The present disclosure relates generally to exoskeleton systems and more specifically to trunk support exoskeleton systems.

### BACKGROUND

It may be desirable to reduce forces in a wearer's back during lumbar flexion (e.g., during stooping or bending).

### SUMMARY

A trunk-supporting exoskeleton, designed to be worn by a person (i.e., the “wearer”) to reduce muscle forces in the wearer's back during forward lumbar flexion comprises a supporting trunk also referred to herein as a “supporting trunk frame” that is configured to be coupled to the wearer's trunk. The exoskeleton also includes first and second thigh links that are designed to be in contact with the wearer's thighs, with each thigh link rotatably coupled to the supporting trunk, allowing for flexion and extension of the respective thigh links relative to the supporting trunk. Additionally, the exoskeleton includes an electric motor, including a motor shaft and a motor housing, with the motor housing secured to the supporting trunk. The electric motor is configured to generate torque on the motor shaft relative to the motor housing. The exoskeleton further incorporates a transmission system, such as a planetary gear transmission system. The transmission system comprising a ring gear, a carrier gear, and a sun gear. The sun gear is coupled to the motor shaft, and the motor generates an actuator torque between the ring gear and the carrier gear. The exoskeleton also includes a ring gear pulley, which is coupled to and rotates with the ring gear, and a carrier pulley, which is coupled to and rotates with the carrier gear. Additionally, the exoskeleton is equipped with a ring gear line, which has a first end wound onto the ring gear pulley and a second end attached to the first thigh link. This configuration allows the actuator torque between the carrier gear and the ring gear to generate a tensile force in the ring gear line, thereby providing an extension torque between the first thigh link and the supporting trunk. Furthermore, the exoskeleton includes a carrier line with a first end wound onto the carrier pulley and a second end attached to the second thigh link. This setup ensures that the actuator torque between the ring gear and the carrier gear generates a tensile force in the carrier line, thereby providing an extension torque between the second thigh link and the supporting trunk. In operation, when the wearer is bent forward, the motor generates an actuator torque between the carrier gear and the ring gear, creating tensile forces in both the carrier line and the ring gear line. This action provides extension torques between the first and second thigh links and the supporting trunk, thereby resisting the bending motion of the supporting trunk.

In some embodiments, the first thigh link comprises a first thigh link pulley and the second thigh link comprises a second thigh link pulley. In some embodiments of invention, the ring gear line is wound on the first thigh link pulley from the ring gear line's second end such that the actuator torque between the ring gear and the carrier gear generates a tensile force in the ring gear line thereby providing an extension torque between the first thigh link and the supporting trunk. The carrier line is wound onto the second thigh pulley from the carrier line's second end such that the actuator torque between the ring gear and the carrier gear generates a tensile force in the carrier line thereby providing an extension torque between the second thigh link and the supporting trunk. In some embodiments, the first thigh link pulley and the second thigh link pulley each have a non-circular shape to reduce the tensile forces in the ring gear line and carrier line.

In operation, when the person is not in the forward-bent position, the motor halts the production of actuator torque between the carrier gear and the ring gear, resulting in a substantially free movement between the ring gear pulley and the carrier pulley, and allowing for the free movement of the first and second thigh links relative to the supporting trunk, as required for walking, ascending, and descending stairs and slopes. In some embodiments, when the person is not in the forward-bent position, the motor generates a substantially small actuator torque between the carrier gear and the ring gear, resulting in only minimal resistance to the movement of the first and second thigh links relative to the supporting trunk during walking, ascending, and descending stairs and slopes. In other embodiments, when the person is not in a forward-bent position and the first and second thigh links are in a reciprocating mode necessary for walking, the motor generates a substantially small torque between the ring gear and the carrier gear, resulting in a nearly free movement of the first and second thigh links relative to the supporting trunk, which is needed for walking. In reciprocating mode, both legs move with velocities opposite to each other. This mode is characteristic of walking, as the legs naturally move in opposite directions during the gait cycle.

The ring gear line and the carrier line each comprise one or more of a wire, cable, belts, fabric rope, plastic rope, cord, twine, chain, wire rope, or string. The motor comprises one or of an AC (alternating current) motor, brush-type DC (direct current) motor, brushless DC motor, electronically commutated motor (ECM), stepper motor, and combinations thereof.

In some embodiments, the motor further includes a transmission system. The transmission system comprises one or more of a harmonic drive, planetary gear, ball screw mechanism, lead screw mechanism, worm gear, and combinations thereof.

Some embodiments described herein are directed to a trunk-supporting exoskeleton for reducing muscle forces in a wearer's back during forward lumbar flexion. The trunk-supporting exoskeleton is configured to be worn by a person to reduce muscle forces in the wearer's back during forward lumbar flexion. The trunk-supporting exoskeleton comprises a supporting trunk configured to be coupled to the wearer's trunk. The trunk-supporting exoskeleton further comprises a first thigh link and a second thigh link, which are configured to be in contact with the wearer's thighs. Each of the first and second thigh links is rotatably coupled to the supporting trunk in a manner that allows for flexion and extension of the respective first and second thigh links relative to the supporting trunk. The trunk-supporting exoskeleton further comprises an actuator, which includes an actuator first element and an actuator second element. In some embodiments, actuator first element may include actuator shaft, and actuator second element may include actuator housing. In some embodiments, actuator first element comprises a ring gear and actuator second element comprises a carrier gear. The actuator is configured to concurrently generate a first actuator torque on the actuator first element and a second actuator torque on the actuator second element, wherein the actuator first element and the actuator second element are arbitrarily and independently rotatable relative to each other. The actuator first element and the actuator second element are coupled to the first thigh link and the second thigh link, respectively, such that arbitrary flexion and extension of the first and second thigh links relative to the supporting trunk rotate the actuator first element and the actuator second element, respectively. When the person is in the forward-bent position, the actuator generates the first actuator torque on the actuator first element and the second actuator torque on the actuator second element to generate extension torques between the first and second thigh links and the supporting trunk, thereby resisting the bending motion of the supporting trunk during the forward-bent position. When the person is not in the forward-bent position, the actuator generates a substantially small first actuator torque and second actuator torque, resulting in small resistance to the movement of the thigh links relative to the supporting trunk during walking, climbing, and ascending stairs and slopes.

In some embodiments, when the person is not in the forward-bent position, the actuator ceases producing the first and second actuator torques on the actuator first element and the actuator second element, resulting in substantially free movement of the actuator first element and the actuator second element. Consequently, this allows for free flexion and extension movements of the first thigh link and the second thigh link relative to the supporting trunk, thereby facilitating the necessary motion for locomotion.

In some embodiments, when the thigh links are in the reciprocating mode required for walking, the actuator generates no or small torque on the actuator first element and the actuator second element, resulting in substantially free rotation between the actuator first element and the actuator second element, and substantially free rotation of the thigh links relative to the supporting trunk, as needed for walking.

In some embodiments, the actuator first element is coupled to the first thigh link via a first line, and the actuator second element is coupled to the second thigh link via a second line. The first line and the second line comprise one or more of a wire, cable, belts, fabric rope, plastic rope, cord, twine, chain, rods, wire rope, or string.

In some embodiments, an actuator first pulley is coupled to the actuator first element and rotates with the actuator first element. An actuator second pulley is coupled to the actuator second element and rotates with the actuator second element. A first line is wound onto the actuator first pulley from a first end of the first line and is coupled to the first thigh link from a second end of the first line, such that the first actuator torque generates a tensile force in the first line, thereby providing an extension torque between the first thigh link and the supporting trunk. A second line is wound onto the actuator second pulley from a first end of the second line and is coupled to the second thigh link from a second end of the second line, such that the second actuator torque generates a tensile force in the second line, thereby providing an extension torque between the second thigh link and the supporting trunk.

In some embodiments, the first thigh link comprises a first thigh link pulley, and the second thigh link comprises a second thigh link pulley. The first line is wound onto the first thigh link pulley from a second end of the first line such that the actuator torque on the first actuator pulley generates a tensile force in the first line, providing an extension torque between the first thigh link and the supporting trunk. The second line is wound onto the second thigh pulley from a second end of the second line such that the second actuator torque generates a tensile force in the second line, providing an extension torque between the second thigh link and the supporting trunk. In some embodiments, the first thigh link pulley and the second thigh link pulley each have a non-circular shape (such as an oval or elliptical shape) to reduce the tensile forces in the first line and the second line. This will lead to smaller required first actuator torque and the second actuator torque.

In some embodiments, the actuator comprises a motor, such as an electric motor, that includes a motor shaft and a motor housing. The motor is configured to generate the first actuator torque on the motor shaft and the second actuator torque on the motor housing. The actuator first element and the actuator second element are coupled to the motor shaft and the motor housing, respectively. In some embodiments, the motor comprises one or more of an AC (alternating current) motor, brush-type DC (direct current) motor, brushless DC motor, electronically commutated motors (ECM), stepper motor, and combinations thereof. In some embodiments, the electric motor further comprises a transmission system. The transmission system may include one or more of harmonic drives, planetary gears, ball screw mechanisms, lead screw mechanisms, or worm gears, and combinations thereof.

In some embodiments, the actuator comprises a motor comprising a motor shaft and a motor housing. The motor is configured to generate a torque on the motor shaft. The actuator further comprises a transmission, such as a planetary gear transmission comprising a ring gear, a carrier gear, and a sun gear wherein the sun gear is coupled the motor shaft. The actuator first element is coupled to the ring gear and the actuator second element is coupled to the carrier gear.

The trunk-supporting exoskeleton includes a controller that is configured to send signals to the actuator to generate the first and second actuator torques when the wearer is bent forward relative to the vertical gravitational line. When the wearer is not bent forward relative to the vertical gravitational line, the controller signals the actuator to produce substantially smaller first and second actuator torques. In some embodiments, the first actuator torque and the second actuator torque are determined by the degree to which the wearer is bent forward relative to the vertical gravitational line. As the angle of the supporting trunk relative to the vertical gravitational line increases, the first and second actuator torques increase. Conversely, as the angle of the supporting trunk frame relative to the vertical gravitational line decreases, the first and second actuator torques decrease.

In some embodiments, the first and second actuator torques are functions of the angular velocity of the supporting trunk frame in the sagittal plane. As the forward bending angular velocity of the supporting trunk in the sagittal plane increases, the first and second actuator torques decrease. Conversely, as the forward bending angular velocity of the supporting trunk frame in the sagittal plane decreases, the first and second actuator torques increase. In some embodiments, the first and second actuator torques increase as the unbending angular velocity of the supporting trunk frame in the sagittal plane increases. Conversely, the actuator torques decrease as the unbending angular velocity of the supporting trunk frame in the sagittal plane decreases.

The trunk-supporting exoskeleton may include a tilt sensor that generates a signal indicative of the angle of the supporting trunk frame relative to the vertical gravitational line in the sagittal plane. The tilt sensor comprises one or more of Inertial Measurement Units (IMUs), inclinometers, encoders, and angle sensors. In some embodiments, either the first actuator torque or the second actuator torque is a function of the tilt signal.

Some embodiments described herein are directed to a trunk supporting exoskeleton for reducing muscle forces in a wearer's back during forward lumbar flexion. The trunk supporting exoskeleton can include a supporting trunk frame, a first thigh link, a second thigh link, an actuator, a shaft pulley, a housing pulley, a shaft line, and a housing line. The supporting trunk frame can be configured to be coupled to the wearer's trunk. The first thigh link can be configured to be coupled to one of the wearer's thighs. The second thigh link can be configured to be coupled to another of the wearer's thighs. Each of the first and second thigh links can be rotatably coupled to the supporting trunk frame such that the respective first or second thigh links can flex or extend relative to the supporting trunk frame. The actuator can be coupled to the supporting trunk frame. The actuator can include an actuator housing and an actuator shaft. The actuator shaft and the actuator housing can be rotatable relative to the supporting trunk frame. The shaft pulley can be coupled to the actuator shaft. The housing pulley can be coupled to the actuator housing. The shaft line can have a first end wound onto the shaft pulley and a second end coupled to the first thigh link. The housing line can have a first end wound onto the housing pulley and a second end coupled to the second thigh link. When the wearer is bent forward relative to a vertical gravitational line in a sagittal plane, the actuator can generate an actuator resistive torque between the actuator housing and the actuator shaft. The actuator resistive torque between the actuator housing and the actuator shaft can generate tensile forces in the housing line and the shaft line, thereby generating extension torques between the respective first and second thigh links and the supporting trunk frame.

In some embodiments, the first thigh link can include a first thigh link pulley. In some embodiments, the second thigh link can include a second thigh link pulley. In some embodiments, the second end of the shaft line is wound onto the first thigh link pulley such that a tensile force in the shaft line provides an extension torque between the first thigh link and the supporting trunk frame. In some embodiments, the second end of the housing line is wound onto the second thigh pulley such that a tensile force in the housing line provides an extension torque between the second thigh link and the supporting trunk frame.

In some embodiments, when the wearer is not bent forward relative to the vertical gravitational line, the actuator does not produce an actuator resistive torque between the actuator housing and the actuator shaft.

In some embodiments, when the wearer is not bent forward relative to the vertical gravitational line, the actuator generates a substantially small actuator resistive torque between the actuator housing and the actuator shaft allowing for substantially free movement of the thigh links.

In some embodiments, when the wearer is not bent forward relative to the vertical gravitational line and the thigh links are in a reciprocating mode indicative of walking, the actuator generates a substantially small actuator resistive torque allowing for substantially free movement of the thigh links.

In some embodiments, the shaft line and the housing line each comprise an element or combination of elements selected from a group consisting of wire, cable, belts, fabric rope, plastic rope, cord, twine, chain, wire rope and string.

In some embodiments, the actuator comprises an element or combination of elements selected from a group consisting of AC (alternating current) motors, brush-type DC (direct current) motors, brushless DC motors, electronically commutated motors (ECMs), stepper motors, and combinations thereof.

In some embodiments, the actuator includes a transmission system.

In some embodiments, the transmission system includes an element or combination of elements selected from a group consisting of harmonic drives, planetary gears, ball screw mechanisms, lead screw mechanisms, worm gears and combinations thereof.

In some embodiments, the transmission system includes an element or combination of elements selected from a group consisting of gears, worm gears, gear trains, pulleys, lines, belts, toothed belts, toothed pulleys, planetary gears, harmonic drives, spur gears, flexible belts, wire ropes, ropes, ball screw mechanisms, and lead screw mechanisms.

In some embodiments, the trunk supporting exoskeleton includes a controller to send a signal to the actuator to generate the actuator resistive torque between the actuator housing and the actuator shaft when the wearer is bent forward relative to the vertical gravitational line.

In some embodiments, the actuator resistive torque is a function of how much the wearer is bent forward relative to the vertical gravitational line.

In some embodiments, the actuator resistive torque increases as an angle of the supporting trunk frame relative to the vertical gravitational line increases.

In some embodiments, the actuator resistive torque decreases as an angle of the supporting trunk frame relative to the vertical gravitational line decreases.

In some embodiments, the actuator resistive torque is a function of an angular velocity of the supporting trunk frame in the sagittal plane.

In some embodiments, the actuator resistive torque decreases as a forward angular velocity of the supporting trunk frame in the sagittal plane increases.

In some embodiments, the actuator resistive torque increases as a forward angular velocity of the supporting trunk frame in the sagittal plane decreases.

In some embodiments, the actuator resistive torque decreases as a backward angular velocity of the supporting trunk frame in the sagittal plane increases.

In some embodiments, the actuator resistive torque increases as a backward angular velocity of the supporting trunk frame in the sagittal plane decreases.

In some embodiments, the controller sends a signal to the actuator to generate a substantially small actuator resistive torque between the actuator housing and the actuator shaft when wearer is not bent forward relative to the vertical gravitational line.

In some embodiments, the trunk supporting exoskeleton includes a tilt sensor and a controller. In some embodiments, the tilt sensor generates a tilt signal indicative of an angle of the supporting trunk frame relative to the vertical gravitational line in the sagittal plane. In some embodiments, the controller sends a signal to the actuator to generate the actuator resistive torque between the actuator housing and the actuator shaft when the tilt signal indicates an angle of the supporting trunk frame relative to the vertical gravitational line that is greater than a predetermined angle.

In some embodiments, the tilt sensor includes an element or combination of elements selected from a group consisting of Inertial Measurement Units (IMU), inclinometers, encoders, and angle sensors.

In some embodiments, the actuator resistive torque is a function of the tilt signal.

In some embodiments, the controller sends a signal to the actuator to generate a substantially small actuator resistive torque between the actuator housing and the actuator shaft when the tilt signal indicates that the wearer is not bent forward relative to the vertical gravitational line.

In some embodiments, the trunk supporting exoskeleton includes a shaft line jacket enclosing the shaft line. In some embodiments, the shaft line jacket is secured to the supporting trunk frame to facilitate a size adjustment of the supporting trunk frame without adjustment to the size of the shaft line.

In some embodiments, the trunk supporting exoskeleton includes a housing line jacket enclosing the housing line. In some embodiments, the housing line jacket is secured to the supporting trunk frame to facilitate a size adjustment of the supporting trunk frame without adjustment to the size of the housing line.

In some embodiments, the actuator generates the actuator resistive torque by use of electric power.

In some embodiments, the actuator includes an actuator spring. In some embodiments, a first end of the actuator spring is coupled to the actuator shaft. In some embodiments, a second end of the actuator spring is free in a first range of rotation of the actuator shaft relative to the actuator housing. In some embodiments, a second end of the actuator spring is constrained by the actuator housing in a second range of rotation of the actuator shaft relative to the actuator housing. In some embodiments, in the first range of rotation, the actuator generates the actuator resistive torque by use of electric power. In some embodiments, in the second range of rotation, the spring generates at least part of the actuator resistive torque.

In some embodiments, the actuator spring comprises an element or combination of elements selected from a group consisting of coil springs, leaf springs, bungee cords, rotary springs, elastomer cords, elastic cords, fabric cords, plastic cords, cords, twine, wire rope elastomers, and string.

In some embodiments, in a first range of rotation of the actuator shaft relative to the actuator housing the actuator generates the actuator resistive torque by use of electric power. In some embodiments, in a second range of rotation of the actuator shaft relative to the actuator housing, the actuator resistive torque is the addition of a torque generated by a spring and a torque generated by use of the electric power.

In some embodiments, the supporting trunk frame comprises a lower frame part configured to partially surround the wearer's trunk and coupled to the first and second thigh links at two sides of the wearer.

In some embodiments, the supporting trunk frame comprises a spine frame part coupled to the lower frame part.

In some embodiments, the spine frame part is adjustable in length to accommodate wearers of various heights.

In some embodiments, the lower frame part is adjustable in width to accommodate wearers of various width sizes.

In some embodiments, the lower frame part is adjustable in depth to accommodate wearers of various depth sizes.

In some embodiments, wherein the supporting trunk frame includes an upper frame part coupled to a spine frame part and configured to impose a supporting trunk force on the wearer's trunk and chest area.

In some embodiments, the upper frame part is configured to rotate relative to the spine frame part along an axis substantially parallel to the wearer's spine.

In some embodiments, the spine frame part is configured to rotate relative to a lower frame part along an axis substantially parallel to the wearer's spine.

In some embodiments, the upper frame part is configured to rotate relative to the spine frame part along an axis substantially parallel to one of the wearer's lumbar spine mediolateral flexion and extension axes.

Some embodiments described herein are directed to a trunk supporting exoskeleton for reducing muscle forces in a wearer's back during forward lumbar flexion. The trunk supporting exoskeleton can include a supporting trunk frame, a first thigh link, a second thigh link, and an actuator. The supporting trunk frame can be configured to be coupled to the wearer's trunk. The first thigh link can be configured to be coupled to one of the wearer's thighs. The second thigh link can be configured to be coupled to another of the wearer's thighs. Each of the first and second thigh links can be rotatably coupled to the supporting trunk frame such that the respective first or second thigh links can flex or extend relative to the supporting trunk frame. The actuator can be coupled to the supporting trunk frame. The actuator can include an actuator housing and an actuator shaft. The actuator can be free to rotate relative to the supporting trunk frame. The actuator shaft can be coupled to the first thigh link and the actuator housing can be coupled to the second thigh link. When the wearer bends forward in a sagittal plane, the actuator can generate an actuator resistive torque between the actuator housing and the actuator shaft, thereby generating extension torques between the respective first and second thigh links and the supporting trunk frame.

In some embodiments, the trunk supporting exoskeleton includes a shaft pulley, a housing pulley, a shaft line, and a housing line. In some embodiments, the shaft pulley is coupled to the actuator shaft. In some embodiments, the housing pulley is coupled to the actuator housing. In some embodiments, the shaft line has a first end wound onto the shaft pulley and a second end coupled to the first thigh link. In some embodiments, the housing line has a first end wound onto the housing pulley and a second end coupled to the second thigh link. In some embodiments, the actuator resistive torque can generate tensile forces in the housing line and the shaft line, thereby generating extension torques between the respective first and second thigh links and the supporting trunk frame.

### BRIEF DESCRIPTION OF THE DRAWINGS

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a perspective view of a person wearing a trunk support exoskeleton.

FIG. 2 shows a perspective view of the trunk support exoskeleton of FIG. 1.

FIG. 3 shows another perspective view of the trunk support exoskeleton of FIG. 1.

FIG. 4 shows a side view of a person wearing the trunk support exoskeleton of FIG. 1, with the person bent forward in the sagittal plane.

FIG. 5 shows a perspective view of an actuator with a housing pulley and a shaft pulley for the trunk support exoskeleton of FIG. 1.

FIG. 6 shows a cross-sectional view of the actuator of FIG. 5.

FIG. 7 shows a perspective view of the actuator of FIG. 5, with the shaft pulley removed for purposes of illustration.

FIG. 8 shows a cross-sectional view of the actuator of FIG. 5, with the shaft pulley removed for purposes of illustration.

FIG. 9 shows a perspective view of the actuator of FIG. 5, with the housing pulley and shaft pulley removed for purposes of illustration.

FIG. 10 shows a cross-sectional view of the actuator of FIG. 5, with the housing pulley and shaft pulley removed for purposes of illustration.

FIG. 11 shows an enlarged view of a portion of the trunk support exoskeleton of FIG. 1.

FIG. 12 shows an enlarged view of a portion of a trunk support exoskeleton showing an alternative connection between a shaft line and thigh link.

FIG. 13 is a schematic showing how a resistive torque between a housing and shaft of an actuator of the trunk support exoskeleton of FIG. 1 generates an extension torque between thigh links and a trunk support frame of the trunk support exoskeleton.

FIG. 14 shows a diagram of forces on a person's back when bending forward in the sagittal plane.

FIG. 15 shows a flow chart of a control algorithm for controlling a trunk support exoskeleton.

FIG. 16 shows an enlarged view of a portion of the trunk support exoskeleton of FIG. 1.

FIG. 17 shows an enlarged view of a portion of the trunk support exoskeleton of FIG. 1.

FIG. 18 shows an enlarged view of a portion of the trunk support exoskeleton of FIG. 1.

FIG. 19 shows a cross-sectional view of an actuator for the trunk support exoskeleton of FIG. 1.

FIG. 20 shows a cross-sectional view of an actuator for the trunk support exoskeleton of FIG. 1, showing an alternative arrangement of a spring of the actuator.

FIG. 21 shows an embodiment of the actuator for the trunk support exoskeleton according to an embodiment.

FIG. 22 shows an exploded view of the actuator shown in FIG. 21.

FIG. 23 shows a schematic diagram showing how actuator of FIG. 21 generates an extension torque between thigh links and a trunk support frame of the trunk support exoskeleton.

FIG. 24 shows a schematic diagram showing how an actuator generates an extension torque between thigh links and a trunk support frame of the trunk support exoskeleton.

FIG. 25 is a flow chart of a control algorithm for controlling a trunk support exoskeleton according to an embodiment.

FIG. 26 a flow chart of a control algorithm for detection of simultaneous walking and bending according to an embodiment.

FIGS. 27A-B show an embodiment of a trunk support exoskeleton having non-circular pulleys.

### DETAILED DESCRIPTION

A trunk support exoskeleton can be used to reduce muscle forces in a wearer's back during lumbar flexion, which occurs during maneuvers such as stooping and bending. A person may wish to wear an exoskeleton to provide support during these activities and also continue wearing the exoskeleton (e.g., for convenience) during other activities, including walking, ascending a slope, or climbing stairs or a ladder. Some embodiments of the present invention provide an exoskeleton that reduces muscle forces in a wearer's back during stooping and bending while also allowing the wearer to comfortably walk, ascend a slope, or climb stairs or a ladder.

In some embodiments, the exoskeleton includes a supporting trunk frame, first and second thigh links, and an actuator that produces an extension torque between the thigh links and supporting trunk frame to provide support to the wearer during stooping or bending.

In some embodiments, the actuator produces an extension torque between the first and second thigh links and the supporting trunk frame only when the wearer is bent forward in a sagittal plane. In some embodiments, the actuator does not produce an extension torque between the first and second thigh links and the supporting trunk frame when a user is walking, ascending, or climbing.

In some embodiments, the actuator generates a torque between a housing of the actuator and a shaft of the actuator, which in turn produces an extension torque between the thigh links and supporting trunk frame. In some embodiments, the torque generated by the actuator between the actuator housing and the actuator shaft is transferred through a system of pulleys and lines to generate the extension torque between the thigh links and supporting trunk frame.

In some embodiments, the actuator housing and actuator shaft can rotate relative to each other (e.g., in response to non-reciprocal motion of thigh links coupled to the actuator housing and actuator shaft, which occurs, e.g., when a wearer's legs do not move in opposite directions at the same speed). Non-reciprocal motion occurs naturally during activities such as walking, ascending, and climbing. For example, during some phases of a walking gait cycle, both legs of a person move in the same direction.

In some embodiments, motion of the first and second thigh links relative to the supporting trunk frame (e.g., while a wearer walks while wearing the trunk support exoskeleton) can transmit forces through a system of lines and pulleys to the actuator housing and actuator shaft. In embodiments in which the actuator housing and actuator shaft can rotate relative to each other, these forces can cause the actuator housing and actuator shaft to rotate relative to each other when the forces are not equal and opposite (i.e., in response to non-reciprocal motion of the thigh links which occurs, for example when a wearer's legs do not move in opposite directions at the same speed). Allowing the actuator housing and actuator shaft to rotate relative to each other in response to non-reciprocal motion of the thigh links can allow a wearer to feel more comfortable when walking, ascending, or climbing while wearing the trunk support exoskeleton. If the actuator housing and actuator shaft could not be rotated relative to each other in response to non-reciprocal motion of the thigh links, tensile forces in the lines connecting the actuator housing and actuator shaft to the first and second thigh links could resist the non-reciprocal motion, making walking, ascending, or climbing uncomfortable or impossible for the user.

In some embodiments, the actuator can rotate relative to the supporting trunk frame (e.g., in response to non-reciprocal motion of thigh links coupled to the actuator housing and actuator shaft).

Allowing the actuator to rotate relative to the supporting trunk frame in response to non-reciprocal motion of the thigh links can allow a wearer to feel more comfortable when walking, ascending, or climbing while wearing the trunk support exoskeleton. If the actuator could not be rotated relative to the supporting trunk frame in response to non-reciprocal motion of the thigh links, tensile forces in the lines connecting the actuator housing and actuator shaft to the first and second thigh links could resist the non-reciprocal motion, making walking, ascending, or climbing uncomfortable or impossible for the user.

These and other embodiments are discussed below in more detail with reference to the figures.

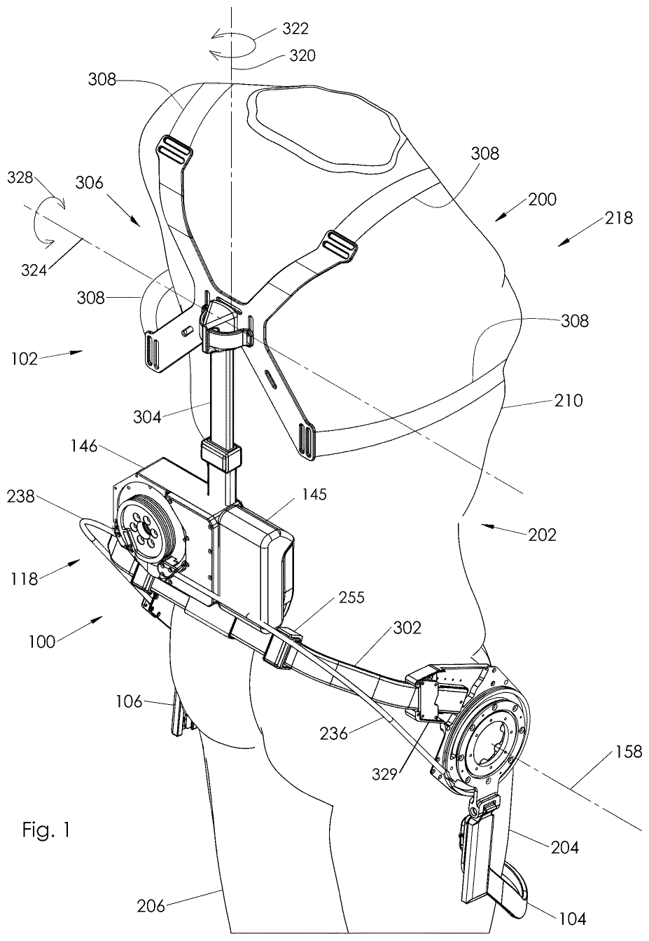

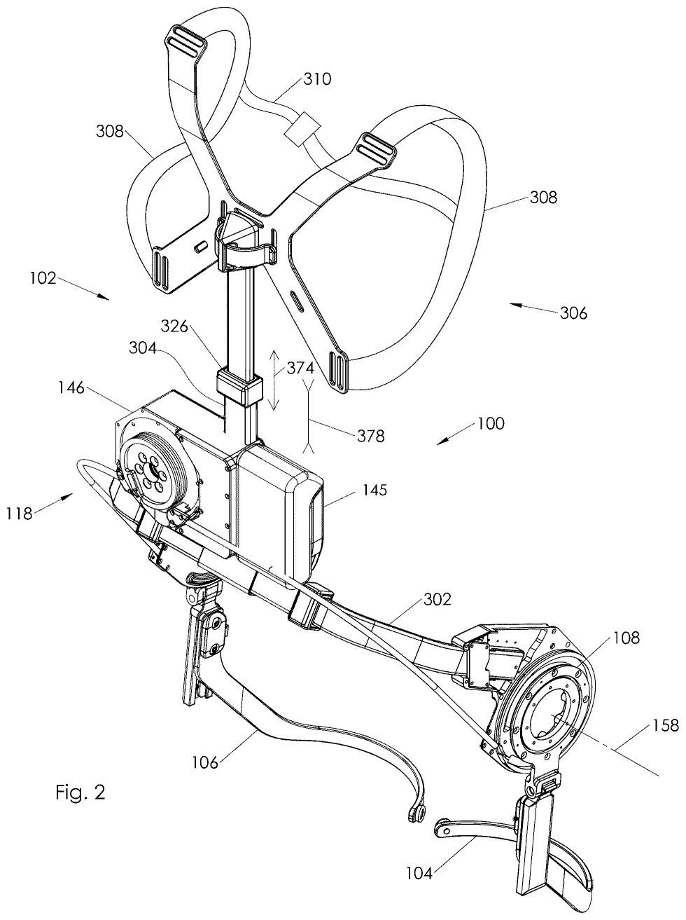

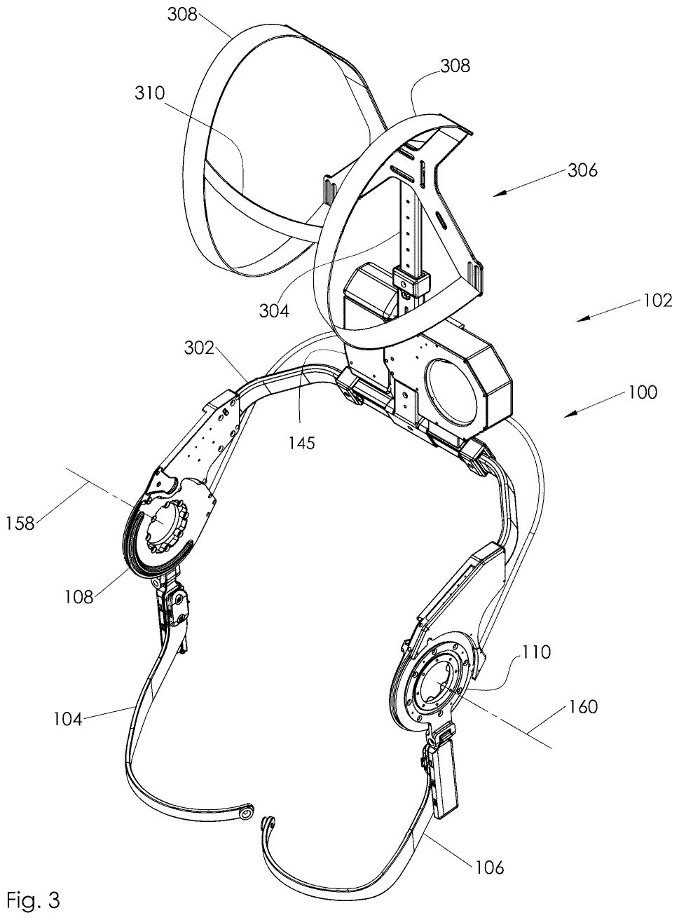

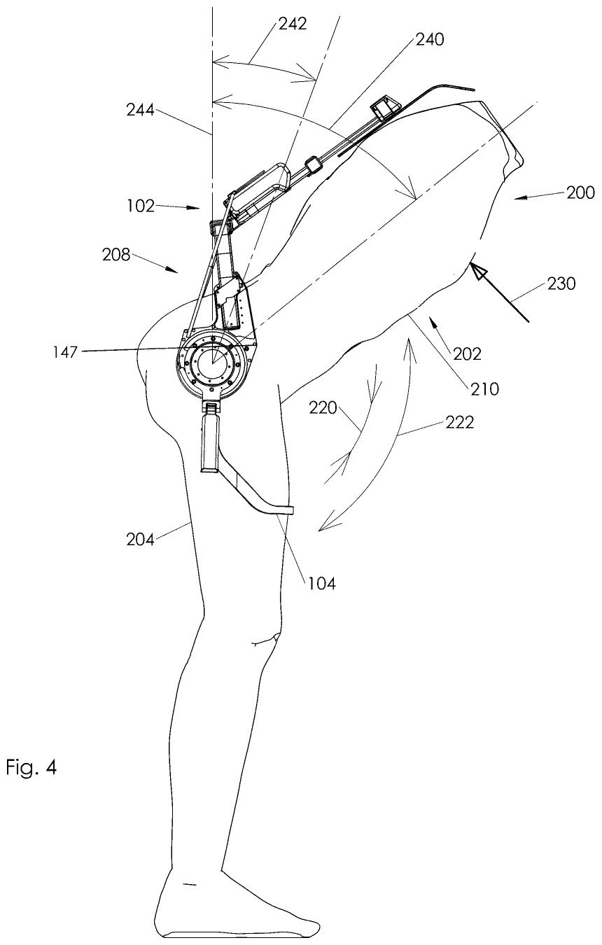

FIGS. 1-4 show an embodiment of a trunk support exoskeleton 100. As will be described, trunk support exoskeleton 100 can be worn by a wearer 200 to reduce muscle forces in the wearer's back during forward lumbar flexion which occurs during maneuvers such as stooping and bending. FIG. 1 shows a perspective view of trunk support exoskeleton 100 worn by a wearer 200. FIG. 2 shows a perspective view of trunk support exoskeleton 100 with wearer 200 removed to further illustrate components of trunk support exoskeleton 100. FIG. 3 shows another perspective view of trunk support exoskeleton 100. FIG. 4 shows wearer 200 wearing trunk support exoskeleton 100 bent forward in a sagittal plane. In this position, forward lumbar flexion is taking place. Angle 240 represents how much wearer 200 has bent along the forward direction.

As shown, for example, in FIG. 1, trunk support exoskeleton 100 can include a supporting trunk frame 102 configured to be coupled to a wearer's trunk 202, a first thigh link 104 and a second thigh link 106 configured to be coupled to respective thighs 204 and 206 of wearer 200, and an actuator 118 that generates an extension torque between first thigh link 104 and supporting trunk frame 102 and between second thigh link 106 and supporting trunk frame 102.

As used here and elsewhere in this disclosure, a wearer's trunk 202 can include the wearer's chest, abdomen, pelvis, and back. The wearer's trunk 202 can be, for example, the wearer's body apart from the head and limbs, or the central part of the wearer from which the neck and limbs extend.

As mentioned, trunk support exoskeleton 100 can include a first thigh link 104 and a second thigh link 106 which are configured to be coupled to respective thighs 204 and 206 of wearer 200. When first thigh link 104 and second thigh link 106 are coupled to respective thighs 204 and 206, first thigh link 104 and second thigh link 106 move in unison with wearer's thighs 204 and 206, respectively, in a manner resulting in flexion and extension of respective first and second thigh links 104 and 106 relative to supporting trunk frame 102.

In some embodiments, first and second thigh links 104 and 106 are rotatably coupled to supporting trunk frame 102 such that the first or second thigh links 104 and 106 can flex or extend relative to supporting trunk frame 102. As shown by arrow 220 in FIG. 4, flexion of first thigh link 104 relative to supporting trunk frame 102 occurs when first thigh link 104 and supporting trunk frame 102 rotate towards each other. Similarly, flexion of second thigh link 106 relative to supporting trunk frame 102 occurs when second thigh link 106 and supporting trunk frame 102 rotate towards each other. As shown by arrow 222 in FIG. 4, extension of first thigh link 104 relative to supporting trunk frame 102 occurs when first thigh link 104 and supporting trunk frame 102 rotate away from each other. Similarly, extension of second thigh link 106 relative to supporting trunk frame 102 occurs when second thigh link 106 and supporting trunk frame 102 rotate away from each other.

As mentioned, and as shown in FIG. 1 and FIG. 2, trunk support exoskeleton 100 can include actuator 118. In some embodiments, as will be discussed, actuator 118 can generate an extension torque between first thigh link 104 and supporting trunk frame 102 and between second thigh link 106 and supporting trunk frame 102 to provide support to the wearer during lumbar flexion. In some embodiments, as will be discussed, actuator 118 is coupled to supporting trunk frame 102 but is free to rotate relative to supporting trunk frame 102.

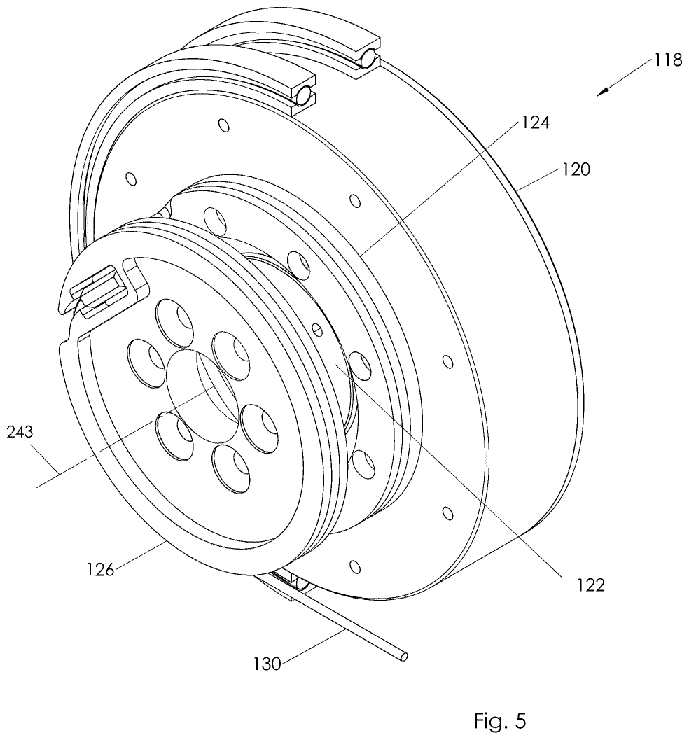

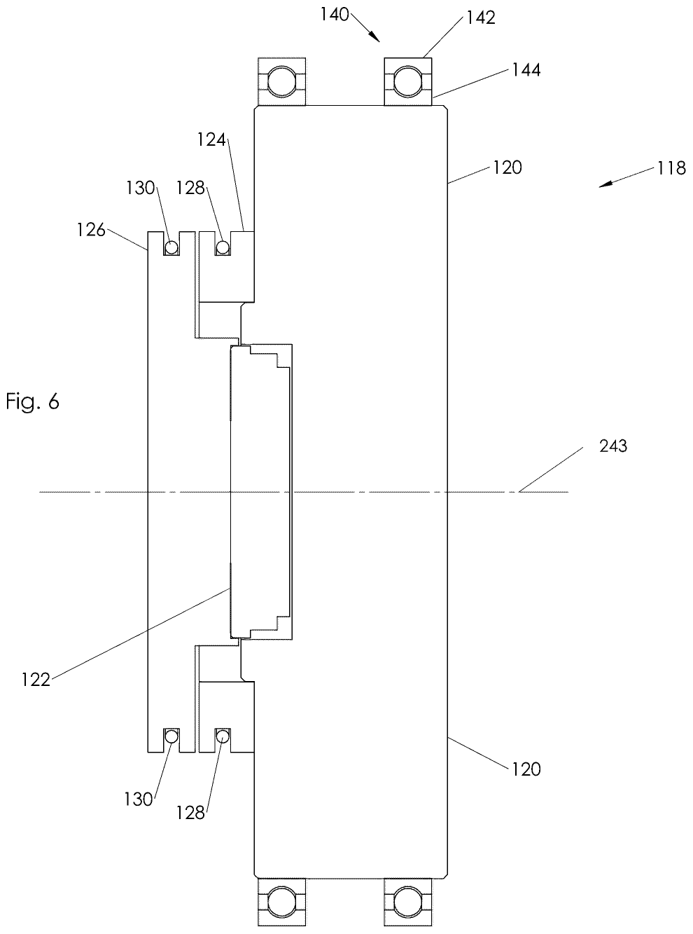

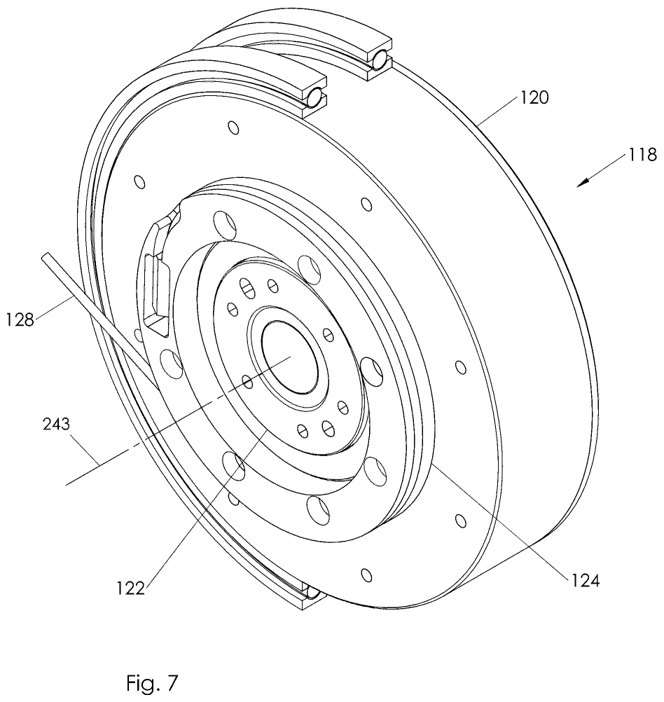

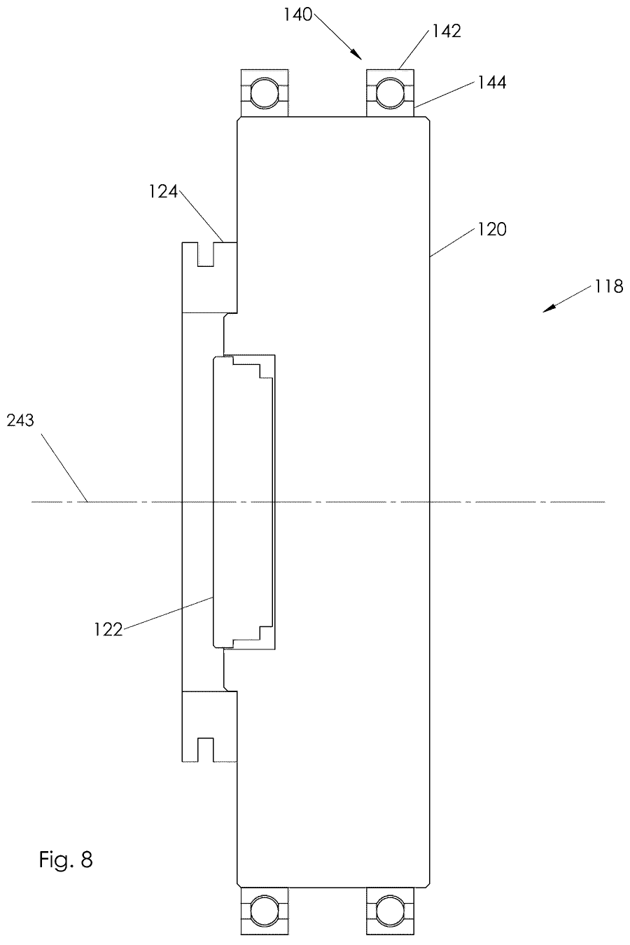

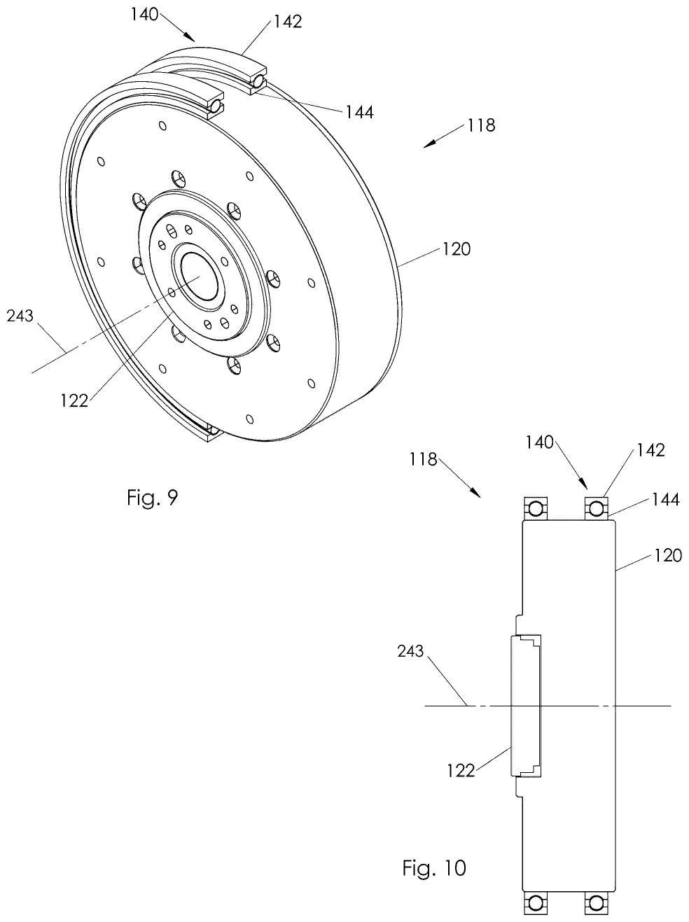

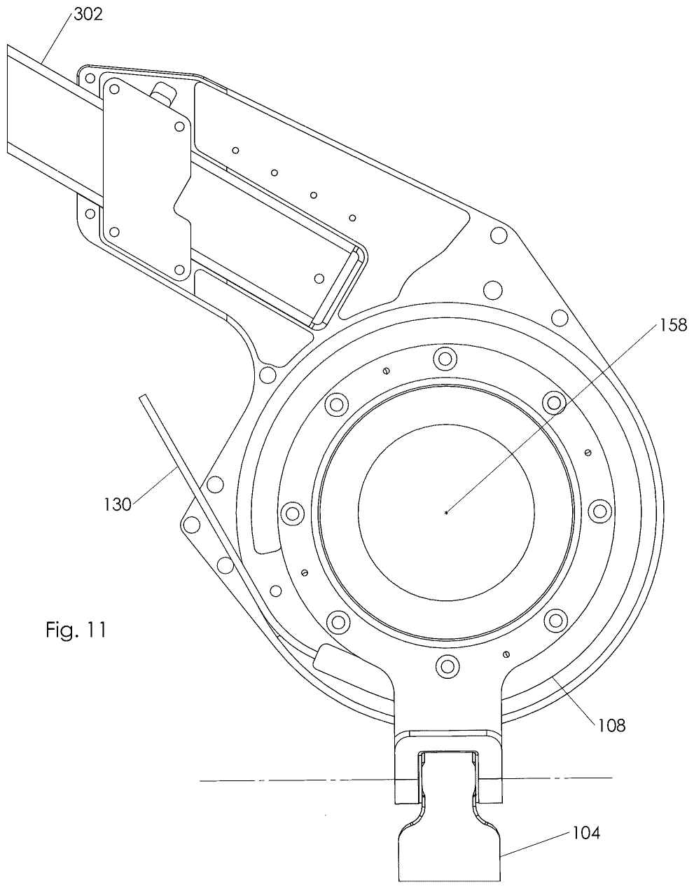

Actuator 118 is discussed below with reference to FIGS. 1 and 5-10. As shown in FIGS. 5 and 6, in some embodiments, actuator 118 includes actuator housing 120, a housing pulley 124, a housing line 128 (shown in FIG. 7), an actuator shaft 122, a shaft pulley 126, and a shaft line 130. In FIGS. 7 and 8, actuator 118 is shown with shaft pulley 126 removed for purposes of illustration. In FIGS. 9 and 10, actuator 118 is shown with housing pulley 124 and shaft pulley 126 removed for purposes of illustration.

In some embodiments, actuator housing 120 and actuator shaft 122 can rotate relative to each other along axis 243. Actuator 118 can be coupled to any point of supporting trunk frame 102. However, both actuator housing 120 and actuator shaft 122 can be free to rotate relative to the supporting trunk frame 102.

In some embodiments, actuator 118 can generate a torque between actuator housing 120 and actuator shaft 122.

As shown in FIGS. 5 and 6, shaft pulley 126 can be coupled to actuator shaft 122 and rotate with actuator shaft 122 (e.g., when actuator 118 generates a torque between actuator housing 120 and actuator shaft 122). Any suitable method can be used to couple shaft pulley 126 and actuator shaft 122 such that shaft pulley 126 and actuator shaft 122 rotate together. For example, fasteners can be used to couple shaft pulley 126 to actuator shaft 122.

As shown in FIGS. 7 and 8, housing pulley 124 can be coupled to actuator housing 120 and rotate with actuator housing 120 along axis 243 (e.g., when actuator 118 generates a torque between actuator housing 120 and actuator shaft 122). Any suitable method can be used to couple housing pulley 124 and actuator housing 120 such that housing pulley 124 and actuator housing 120 rotate together. For example, fasteners can be used to couple housing pulley 124 and actuator housing 120.

In some embodiments, a first end of shaft line 130 can be coupled to (e.g., wound onto) shaft pulley 126, and a second end of shaft line 130 can be coupled to first thigh link 104 such that a tensile force in shaft line 130 (generated, for example, by a torque generated by actuator 118 between actuator housing 120 and actuator shaft 122) generates an extension torque between first thigh link 104 and supporting trunk frame 102.

Shaft line 130 can be or include any device or combination of devices capable of performing the indicated functions. Examples of shaft line 130 include, without limitation, wire, cable, belts, fabric rope, plastic rope, cord, twine, chain, bicycle-type chain, wire rope, string, and combinations thereof. In some embodiments, shaft line 130 comprises a multi-strand wire rope having a maximum strength of about 200 pounds.

In some embodiments, a first end of housing line 128 can be coupled to (e.g., wound onto) housing pulley 124, and a second end of housing line 128 can be coupled to second thigh link 106 such that a tensile force in housing line 128 (generated, for example, by a torque generated by actuator 118 between actuator housing 120 and actuator shaft 122) generates an extension torque between second thigh link 106 and supporting trunk frame 102.

Housing line 128 can be or include any device or combination of devices capable of performing the indicated functions. Examples of housing line 128 include, without limitation, wire, cable, belts, fabric rope, plastic rope, cord, twine, chain, bicycle-type chain, wire rope, string, and combinations thereof. In some embodiments, housing line 128 comprises a multi-strand wire rope having a maximum strength of about 200 pounds.

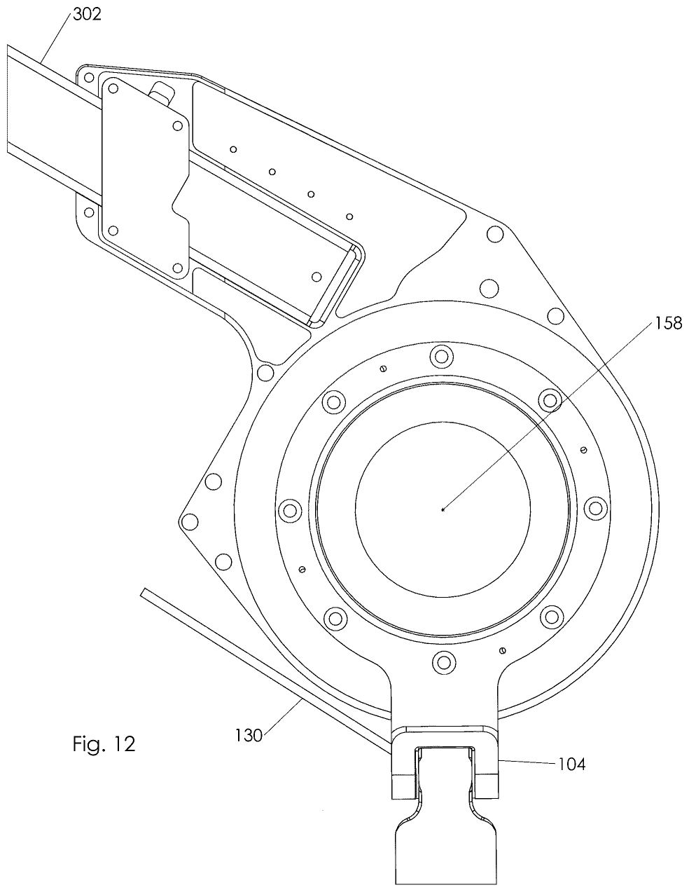

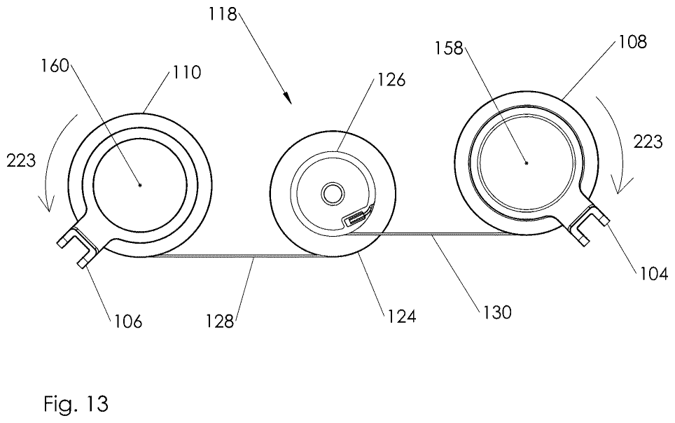

In some embodiments, for example as shown in FIG. 11, first thigh link 104 includes a first thigh link pulley 108 that rotates with first thigh link 104 about axis 158 relative to supporting trunk frame 102. In some embodiments, the second end of shaft line 130 is coupled to (e.g., wound onto) first thigh link pulley 108 such that a tensile force in shaft line 130 generates an extension torque between first thigh link 104 and supporting trunk frame 102. In some embodiments, for example as shown in FIG. 12, the second end of shaft line 130 is directly connected to first thigh link 104 such that a tensile force in shaft line 130 generates a torque about axis 158.

In some embodiments, second thigh link 106 includes a second thigh link pulley 110 that rotates with second thigh link 106 about axis 160 relative to supporting trunk frame 102. In some embodiments, the second end of housing line 128 is coupled to (e.g., wound onto) second thigh link pulley 110 such that a tensile force in housing line 128 generates an extension torque between second thigh link 106 and supporting trunk frame 102. In some embodiments, the second end of housing line 128 is directly connected to second thigh link 106 such that a tensile force in housing line 128 generates a torque about axis 160.

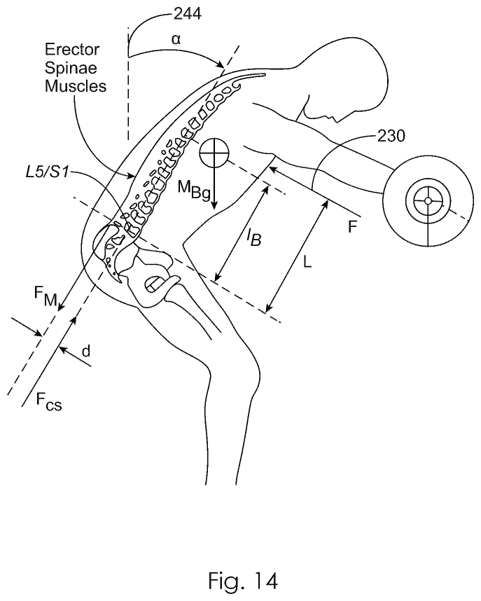

As mentioned, in some embodiments, actuator 118 can generate torque between actuator housing 120 and actuator shaft 122. FIG. 13 schematically shows how this torque can be transferred through the system of pulleys and lines described above. In FIG. 13, the system is flattened into a two-dimensional schematic to show the torque transfer. As shown in FIG. 13, when actuator 118 generates a resisting torque between actuator housing 120 and actuator shaft 122, the torque is transferred to housing pulley 124 (which is coupled to and rotates with actuator housing 120) and shaft pulley 126 (which is coupled to and rotates with actuator shaft 122). In turn, the torque transferred to housing pulley 124 and shaft pulley 126 produce tensile forces in housing line 128 and shaft line 130. These tensile forces provide extension torques between thigh links 104 and 106 and supporting trunk frame 102 in the direction of arrows 222.

In FIGS. 5 and 6, shaft pulley 126 and housing pulley 124 have equal diameters. However, in other embodiments (e.g., as shown in FIG. 13), shaft pulley 126 and housing pulley 124 can have unequal diameters. In the embodiment illustrated in FIGS. 1-4, first thigh link pulley 108 and second thigh link pulley 110 have equal diameters. However, in other embodiments, first thigh link pulley 108 and second thigh link pulley 110 can have unequal diameters. In embodiments in which shaft pulley 126 and housing pulley 124 have equal diameters, and first thigh link pulley 108 and second thigh link pulley 110 have equal diameters, torque between actuator housing 120 and actuator shaft 122 is transferred equally to thigh links 104 and 106. As a result, the extension torque between supporting trunk frame 102 and the thigh links will be equal to twice the torque actuator 118 generates. However, in embodiments in which shaft pulley 126 and housing pulley 124 have unequal diameters, or first thigh link pulley 108 and second thigh link pulley 110 have unequal diameters, unequal torque can transferred to thigh links 104 and 106.

Returning to FIG. 4, in operation, when wearer 200 is bent forward in a sagittal plane such that a predetermined portion 147 of supporting trunk frame 102 passes beyond a predetermined angle 242 from vertical gravitational line 244, actuator 118 can generate a resistive torque between actuator housing 120 and actuator shaft 122. As discussed, this resistive torque can create tensile forces in housing lines 128 and shaft line 130 (e.g., via torque generated between housing pulley 124 and shaft pulley 126), which can then produce extension torques between supporting trunk frame 102 and first and second thigh links 104 and 106. The extension torque between thigh link 104 and supporting trunk frame 102 can try to rotate first thigh link 104 and supporting trunk frame 102 away from each other. Similarly, the extension torque between second thigh link 106 and supporting trunk frame 102 can try to rotate second thigh link 106 and supporting trunk frame 102 away from each other.

The extension torque between supporting trunk frame 102 and first and second thigh links 104 and 106 can impose a supporting trunk force 230 (indicated in FIG. 4) against wearer's trunk 202. Supporting trunk force 230 imposed by supporting trunk frame 102 against wearer's trunk 202 can help reduce the muscle forces at the wearer's lower back at the general area of 208. In the embodiment of FIG. 4, supporting trunk force 230 is generally imposed on wearer's chest area 210. However, supporting trunk force 230 can be imposed on a different portion of wearer's trunk 202 depending on the design of an upper frame part 306 of supporting trunk frame 102. At the same time, first and second thigh links 104 and 106 can impose a force onto wearer's thighs 204 and 206.

In some embodiments, when wearer 200 is not bent forward in the sagittal plane (i.e. when predetermined portion 147 of supporting trunk frame 102 does not pass beyond predetermined angle 242 from vertical gravitational line 244), actuator 118 does not generate a resistive torque between actuator shaft 122 and actuator housing 120. In such embodiments, actuator 118 does not generate an extension torque between supporting trunk frame 102 and first and second thigh links 104 and 106. This means as long as wearer 200 is not bent forward in the sagittal plane, wearer 200 can walk, ascend and descend stairs and ramps without any force imposed on wearer 200 from supporting trunk frame 102.

However, if wearer 200 bends forward in the sagittal plane (i.e. when a predetermined portion 147 of supporting trunk frame 102 passes beyond predetermined angle 242 from vertical gravitational line 244 as shown in FIG. 12), supporting trunk force 230 from supporting trunk frame 102 will help support wearer's trunk 202.

Examples of predetermined angle 242 can be 5, 10 or 15 degrees. In some embodiments, predetermined angle 242 can be zero.

In some embodiments, when wearer 200 is not bent forward in the sagittal plane, actuator 118 generates a substantially small resistive torque between actuator shaft 122 and actuator housing 120. This substantially small resistive torque, generated by actuator 118, can allow for substantially free movement of thigh links 104 and 106 relative to supporting trunk frame 102. This substantially small resistive torque, generated by actuator 118, can cause thigh links 104 and 106 to remain in contact with wearer's thighs during walking. This substantially small resistive torque, generated by actuator 118, can be chosen small enough not to resist or impede the wearer during walking, but cause the thigh links to move in unison with the wearer's thighs.

As mentioned, a person may wish to wear exoskeleton 100 to provide support when bent forward in the sagittal plane as described above and also continue wearing exoskeleton 100 (e.g., for convenience) during other activities, including walking, ascending a slope, or climbing stairs or a ladder. In some embodiments, to enable a wearer to comfortably walk, ascend a slope, or climb stairs or a ladder while wearing exoskeleton 100, actuator housing 120 and actuator shaft 122 can rotate relative to each other along axis 243 in response to non-reciprocal motion of thigh links 104 and 106, which can occur, for example, when a wearer's legs do not move in opposite directions at the same speed.

In some embodiments, actuator housing 120 and actuator shaft 122 can rotate relative to each other in response to non-reciprocal motion of thigh links 104 and 106 when actuator 118 does not generate a resistive torque between actuator housing 120 and actuator shaft 122 (e.g., when wearer 200 is not bent forward in the sagittal plane).

In some embodiments, actuator housing 120 and actuator shaft 122 can rotate relative to each other in response to non-reciprocal motion of thigh links 104 and 106 while actuator 118 generates a substantially small resistive torque between actuator housing 120 and actuator shaft 122.

In some embodiments, extension of first thigh link 104 or second thigh link 106 relative to supporting trunk frame 102 (e.g., when wearer 200 walks) can transmit forces through the system of lines 128, 130 and pulleys 124, 126 described above to actuator shaft 122 and actuator housing 120. In embodiments in which actuator housing 120 and actuator shaft 122 can rotate relative to each other, these forces can cause actuator housing 120 and actuator shaft 122 to rotate relative to each other when the forces are not equal and opposite (e.g., in response to non-reciprocal motion of the wearer's legs). If actuator housing 120 and actuator shaft 122 could not be rotated relative to each other in response to non-reciprocal motion of a person's legs, tensile force in lines 128, 130 connecting actuator housing 120 and actuator shaft 122 to first and second thigh links 104, 106 could resist the non-reciprocal motion of thigh links 104 and 106 relative to supporting trunk frame 102, making walking, ascending, or climbing uncomfortable or impossible for the wearer.

In some embodiments, to enable a wearer to comfortably walk, ascend a slope, or climb stairs or a ladder while wearing exoskeleton 100, actuator 118 is rotatably coupled to supporting trunk frame 102 such that actuator 118 is free to rotate relative to supporting trunk frame 102. In some embodiments, there could be a friction torque that opposes the rotation of actuator 118 relative to supporting trunk frame 102.

Actuator 118 can be coupled to supporting trunk frame 102 via any suitable mechanism that allows actuator 118 to rotate with respect to supporting trunk frame 102. For example, in some embodiments, actuator 118 is coupled to supporting trunk frame 102 via a ball bearing mechanism. As another example, in some embodiments, a bushing can allow rotation of actuator 118 relative to supporting trunk frame 102. In the embodiment illustrated in FIGS. 1-10, for example, an outer race 142 of ball bearing 140 (shown in FIG. 9) is coupled to supporting trunk frame 102, and an inner race 144 of ball bearing 140 is coupled to actuator housing 120. This arrangement allows actuator housing 120 to rotate relative to supporting trunk frame 102.

The coupling of actuator housing 120 to supporting trunk frame 102 is not limited to the arrangement shown. Rather, actuator housing 120 can be coupled to supporting trunk frame 102 via any suitable mechanism that allows actuator housing 120 to rotate with respect to supporting trunk frame 102. One can, for example, use a bushing to allow for rotation of actuator housing 120 relative to supporting trunk frame 102.

As mentioned, in some embodiments, actuator 118 is rotatable relative to supporting trunk frame 102, and in some embodiments, actuator housing 120 and actuator shaft 122 are rotatable relative to each other. In some embodiments, actuator 118 is rotatable relative to supporting trunk frame 102, and actuator housing 120 and actuator shaft 122 are rotatable relative to each other. That is, in some embodiments, actuator housing 120 and actuator shaft 122 are rotatable relative to supporting trunk frame 102 and relative to each other.

In some embodiments, trunk support exoskeleton 100 includes a controller 146 which sends a signal to actuator 118 to generate a resistive torque between actuator housing 120 and actuator shaft 122 (e.g., when wearer 200 is bent forward in the sagittal plane as discussed). Controller 146 can be or include any device or combination of devices capable of performing the indicated functions. Examples of controller 146 include without limitation, analog devices; analog computation modules; digital devices including, without limitation, small-, medium-, and large-scale integrated circuits, application specific integrated circuits, programmable gate arrays, and programmable logic arrays; and digital computation modules including, without limitation, microcomputers, microprocessors, microcontrollers, and programmable logic controllers. In some embodiments controller 146 includes an element or combination of elements selected from a group consisting of electromechanical relays or MOSFET switches.

In some embodiments, trunk support exoskeleton 100 includes a tilt sensor 150 which generates a tilt signal 156. In some embodiments, tilt signal 156 can be indicative of an angle of supporting trunk frame 102 from vertical gravitational line 244 in a sagittal plane. This angle is shown by 240 in FIG. 4.

Tilt sensor 150 can be or include any device or combination of devices capable of performing the indicated functions. Examples of tilt sensor 150 include, without limitation, Inertial Measurement Units (IMU), inclinometers, encoders, and angle sensors.

In operation, controller 146 can send a signal to actuator 118 to generate a resistive torque between actuator housing 120 and actuator shaft 122 when tilt signal 156 indicates that wearer 200 or supporting trunk frame 102 is bent forward in the sagittal plane (i.e., when the tilt signal indicates that an angle of supporting trunk frame 102 from vertical gravitational line 244 in a sagittal plane is greater than predetermined angle 242). As discussed, the resistive torque generated between actuator housing 120 and actuator shaft 122 can generate tensile forces in housing lines 128 and shaft line 130, and the tensile forces in housing line 128 and shaft line 130 can provide extension torques between supporting trunk frame 102 and thigh links 104 and 106.

The following shows an example calculation of the resistive torque of actuator 118.

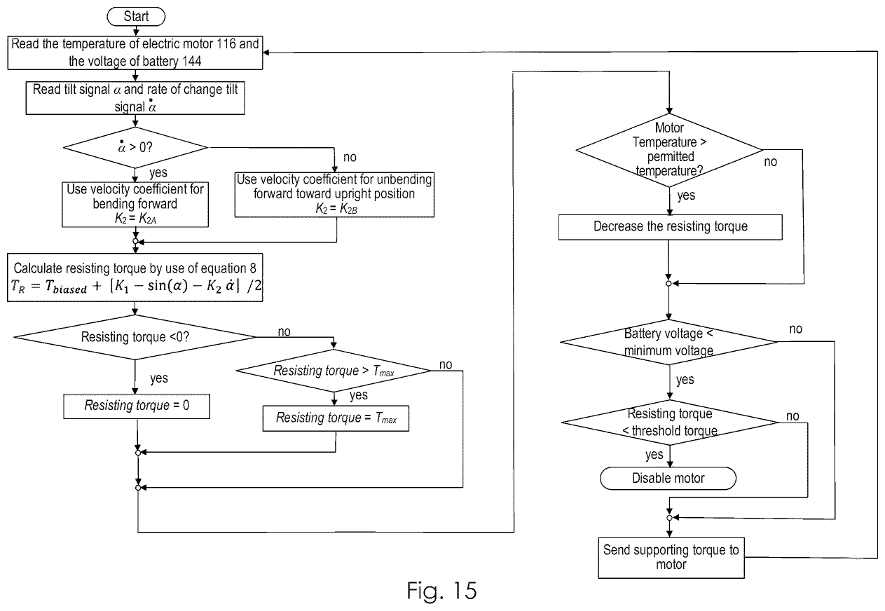

For context, FIG. 14 shows a diagram of forces on a person's back when bending forward in the sagittal plane in the absence of a trunk support exoskeleton. In a static or a quasi-static case and in the absence of any load being lifted by the person, the bending moment (torque) imposed at L5/S1 can be represented by [M_{B} g l_{B} sin (∝)] where M_{B} represents the mass of the person's upper body (including the person's trunk, head and arms), and a part being lifted by person's arms, g represents the gravity acceleration, and l_{B} is the distance between the upper body center of mass and L5/S1 point. ∝ represents the angle of the person's trunk from vertical gravitational line 244. The bending moment increases during load handling and dynamic maneuvers.

As mentioned, when wearer 200 wearing trunk support exoskeleton 100 is bent forward in the sagittal plane, actuator 118 can create an extension torque between supporting trunk frame 102 and first and second thigh links 104 and 106. The extension torque produced by actuator 118 can produce supporting trunk force 230 onto the wearer opposing the bending moment due to the torso and part weight. This means the bending moment (torque) imposed at L5/S1 can be reduced to a new value: [(M_{B}l_{B}) g sin (∝)−FL] where L is the distance from supporting trunk force 230 to point L5/S1 as shown in FIG. 14. This shows the basic concept of a trunk support exoskeleton, where trunk support exoskeleton decreases the bending moment at L5/S1 and consequently decreases the likelihood of injuries during repetitive maneuvers.

Erector spinae muscle tensile force F_{M} decreases as supporting trunk force 230 increases. In a more general case, erector spinae muscle force F_{M}, with the angular speed and acceleration of \dot{∝} and \ddot{∝}, can be expressed as:

$${F}_{M} = ( {M}_{B} {l}_{B} ) \frac{g}{d} sin ( α ) - \frac{FL}{d} - \ddot{∝} \frac{I}{d} - C \dot{∝} \frac{1}{d} \qquad ( 1 )$$

C is a constant and C \dot{∝} represents the velocity dependent torque. I is the effective moment of inertia of the upper body and \ddot{∝}I represents the acceleration dependent torque.

Spine compression force F_{CS} similarly decreases as supporting trunk force 230 is increased and can be expressed as:

$${F}_{CS} = ( {M}_{B} {l}_{B} ) \frac{g}{d} sin ( ∝ ) + ( {M}_{B} ) g cos ( ∝ ) - ( {M}_{B} {l}_{B} ) {\dot{∝}}^{2} - \ddot{∝} \frac{I}{d} - \dot{∝} \frac{C}{d} - \frac{FL}{d} \qquad ( 2 )$$

This analysis assumes F_{CS} and F_{M} to act perpendicularly to supporting trunk force 230. In theory, if the exoskeleton supporting torque FL is chosen as equation (3), then force F_{M}, reduces to zero (equation 4) and force F_{CS}, reduces substantially (equation 5):

$$FL = ( {M}_{B} {l}_{B} ) g sin ( ∝ ) - I \ddot{∝} - C \dot{∝} \qquad ( 3 )$$

$${F}_{M} = 0 \qquad ( 4 )$$

$${F}_{CS} = ( {M}_{B} ) g cos ( ∝ ) - ( {M}_{B} {l}_{B} ) {\dot{∝}}^{2} \qquad ( 5 )$$

This means, in theory, it is possible to reduce the erector spinae muscle force, F_{M}, to zero and the spine compression force, F_{CS}, to a smaller value by controlling supporting trunk force 230 acting on wearer 200. However, the parameters in equation (3) can be difficult to measure or calculate precisely. For example, M_{B} is not a known quantity, l_{B} is simply estimates, and the measurements of ∝ is not precise. Nevertheless, any attempt to cancel the terms of equation (1) by use of equation (3) will lead to a reduction of the spine compression force, F_{CS} and erector spinae muscle force F_{M}. In most cases, bending acceleration \ddot{∝} is negligible. As these equations demonstrate, when supporting trunk force 230 is increased, both erector spinae muscle force and the spine compression force (shown by F_{CS} and F_{M}) are decreased.

The term F L is referred to as supporting torque because it supports wearer 200 during bending and stooping. As can be seen from FIG. 14, this supporting torque is an extension torque. In some embodiments, exoskeleton supporting torque F L can be chosen as

$$FL = {K}_{1} sin ( ∝ ) - {K}_{2} \dot{∝} \qquad ( 6 )$$

K₁ and, K₂ represent approximate values of parameters of equation (3) if acceleration \ddot{∝} is negligible. As shown by equation (6), the exoskeleton supporting torque FL, in some embodiments, comprises a torque which is a function of angle of ∝. In some embodiments, as shown by equation (6), the exoskeleton supporting torque FL comprises a torque which is a function of the angular speed of the supporting trunk frame \dot{∝}. The acceleration dependent term, I\ddot{∝}, in some applications is small and can be neglected. If \ddot{∝} can be measured or estimated with little noise, then the inclusion of I\ddot{∝}, in equation (6) can improve the device performance.

If shaft pulley 126 and housing pulley 124 have equal diameters, and if first thigh link pulley 108 and second thigh link pulley 110 have equal diameters, then the resistive torque of actuator 118, indicated by T_{R}, is represented by equation (7)

$${T}_{R} = \frac{[ FL ]}{2} = [ {K}_{1} sin ( ∝ ) - {K}_{2} \dot{∝} ] / 2 \qquad ( 7 )$$

In some embodiments, the resistive torque, as shown by equation 7, is a function of tilt signal 156. In some embodiments, the resistive torque is a function of how much the wearer is bent forward in the sagittal plane. In some embodiments, the resistive torque increases as the angle of the supporting trunk frame 102 from vertical gravitational line 244 increases. In some embodiments, the resistive torque decreases as the angle of the supporting trunk frame 102 from vertical gravitational line 244 decreases. In some embodiments, the resistive torque is a function of the angular velocity of supporting trunk frame 102 in the sagittal plane. In some embodiments, the resistive torque decreases as the forward angular velocity of supporting trunk frame 102 in the sagittal plane increases. This can, for example, allow wearer 200 to bend forward in the sagittal plane with little effort to push against supporting trunk frame 102. In some embodiments, the resistive torque increases as the forward angular velocity of supporting trunk frame 102 in the sagittal plane decreases. In some embodiments, the resistive torque decreases as the backward angular velocity of the supporting trunk frame 102 in the sagittal plane increases. In some embodiments, the resistive torque increases as the backward angular velocity of supporting trunk frame 102 in the sagittal plane decreases.

In some embodiments, controller 146 stops sending a signal to actuator 118 to generate resistive torque according to equation (7) when tilt signal 156 indicates that wearer 200 is no longer bent forward in the sagittal plane.

In some embodiments, controller 146 sends a signal to actuator 118 to generate a substantially small resistive torque between actuator housing 120 and actuator shaft 122 when tilt signal 156 indicates that wearer 200 is not bent forward in the sagittal plane.

In some embodiments, controller 146 sends a signal to actuator 118 to generate a zero torque when tilt signal 156 indicates that wearer 200 is not bent forward in the sagittal plane.

In some embodiments, actuator 118 provides a small amount of tensile force in housing line 128 and shaft line 130 by providing a biased resistive torque, T_{biased}, in equation 7. T_{biased}, shown in equation 8, causes leads to small initial tensile force in housing line 128 and shaft line 130.

$${T}_{R} = {T}_{biased} + [ {K}_{1} sin ( ∝ ) - {K}_{2} \dot{∝} ] / 2 \qquad ( 8 )$$

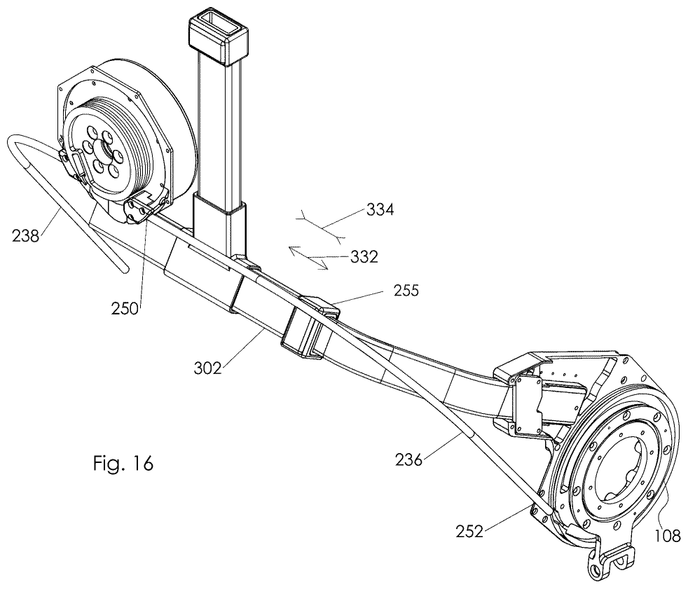

FIG. 15 shows a flowchart of a control algorithm for exoskeleton 100. The control software can start by reading one or more of the voltage of battery 145, the temperature of actuator 118 or a component thereof (e.g., an electric motor 116), tilt signal 156, or the rate of change of tilt signal 156.

In embodiments in which the voltage of battery 145 is checked, if the voltage of battery 145 is less than a minimum voltage, and the calculated resistive toque is smaller than a threshold torque, then actuator 118 can be disabled.

In embodiments in which the actuator temperature is checked, if the actuator temperature is larger than a permitted temperature, the resistive torque can be decreased.

In embodiments in which tilt signal 156 and/or the rate of change of tilt signal 156 is read, a resistive torque for actuator 118 can be calculated using equation 8. If \dot{α} is positive (i.e. wearer 200 is bending forward in the sagittal plane,) coefficient K₂, (used in equation 6) can be chosen as K_{2F}. Otherwise, coefficient K₂ can be chosen as K_{2B}. In some embodiments, K_{2F} is larger than K_{2B}. This allows the resistive torque to be smaller when bending forward in the sagittal plane. The values of K_{2F} and K_{2B} can be chosen to provide appropriate comfort for wearer 200.

In some embodiments, the calculated resistive torque can be checked to see if it is negative or positive. In some embodiments, if the calculated resisting toque is negative, the resistive torque can be set to zero.

In some embodiments, the resistive torque can be checked to see if it is larger than a maximum torque of actuator 118 (or a maximum torque that can be generated by electric motor 116 of actuator 118). This maximum torque is referred to as Tₘₐₓ. If the calculated value of the resisting torque is larger than the maximum torque Tₘₐₓ, then the resistive torque can be set as Tₘₐₓ.

Additional aspects relating to supporting trunk frame 102 will now be discussed with reference to FIG. 1 and FIGS. 16-18. As shown in FIG. 1, in some embodiments, supporting trunk frame 102 includes a lower frame part 302, a spine frame part 304, and an upper frame part 306.

As shown in FIG. 1, in some embodiments, lower frame part 302 is substantially located behind wearer 200 when trunk support exoskeleton 100 is worn. In some embodiments, lower frame part 302 is configured to partially surround wearer's trunk 202 and hips. In some embodiments, lower frame part 302 is coupled to first and second thigh links 104 and 106 from two sides of wearer 200.

Spine frame part 304 can be coupled to (e.g., rotatably coupled to) lower frame part 302. In some embodiments, spine frame part 304 is rotatable about axis 320 with respect to lower frame part 302. This can, for example, allow wearer 200 to freely rotate his upper body relative to his lower body. In some embodiments, axis 320 is substantially parallel to the wearer's spine. Arrow 322 shows the direction of rotation of spine frame part 304 relative to lower frame part 302 about axis 320. In some embodiments, spine frame part 304 is located behind wearer 200 when trunk support exoskeleton 100 is worn.

Upper frame part 306 can be coupled to (e.g., rotatably coupled to) spine frame part 304. In some embodiments, upper frame part 306 is rotatable about axis 320 with respect to spine frame part 304. This can, for example, allow wearer 200 to freely rotate his upper body relative to his lower body. In some embodiments, axis 320 is substantially parallel to the wearer's spine. Arrow 322 shows the direction of rotation of upper frame part 306 relative to spine frame part 304 about axis 320. In some embodiments, upper frame part 306 is rotatable about axis 324 relative to spine frame part 304. This can, for example, allow wearer 200 to freely rotate his upper body relative to his lower body. In some embodiments, axis 324 is substantially parallel to one of the wearer's lumbar spine mediolateral flexion and extension axes. Arrow 328 shows the direction of rotation of upper frame part 306 relative to spine frame part 304 about axis 324.

In some embodiments, upper frame part 306 is configured to contact a wearer's trunk 202 such that upper frame part 306 can impose a force (e.g., supporting trunk force 230 shown in FIG. 6) on a front part of wearer's trunk 202. In some embodiments, upper frame part 306 is configured to contact a chest area 210 of wearer's trunk 202 such that upper frame part 306 can impose a force (e.g., supporting trunk force 230 shown in FIG. 4) on a chest area of wearer's trunk 202. In some embodiments, upper frame part 306 is configured to contact a shoulder area 218 of wearer's trunk 202 such that upper frame part 306 can impose a force (e.g., supporting trunk force 230) on a shoulder area 218 of wearer's trunk 202. As shown in FIG. 2 and FIG. 3, in some embodiments, upper frame part 306 includes shoulder straps 308. In some embodiments, as shown in FIG. 2 and FIG. 3, upper frame part 306 includes chest straps 310.

As mentioned, in some embodiments, spine frame part 304 is rotatable with respect to lower frame part 302, and in some embodiments, upper frame part 306 is rotatable with respect to spine frame part 304. In some embodiments, both upper frame part 306 is rotatable with respect to spine frame part 304 and spine frame part 304 is rotatable with respect to lower frame part 302.

In some embodiments, a height of supporting trunk frame 102 is adjustable. In some embodiments, supporting trunk frame 102 includes an adjustment mechanism 326 (shown in FIG. 2) to adjust the height of supporting trunk frame 102. For example, in some embodiments, upper frame part 306 is configured to slide linearly along spine frame part 304 to adjust a height supporting trunk frame 102. In some embodiments, a height of supporting trunk frame 102 can be increased or decreased as shown by arrows 374 and 378 in FIG. 2.

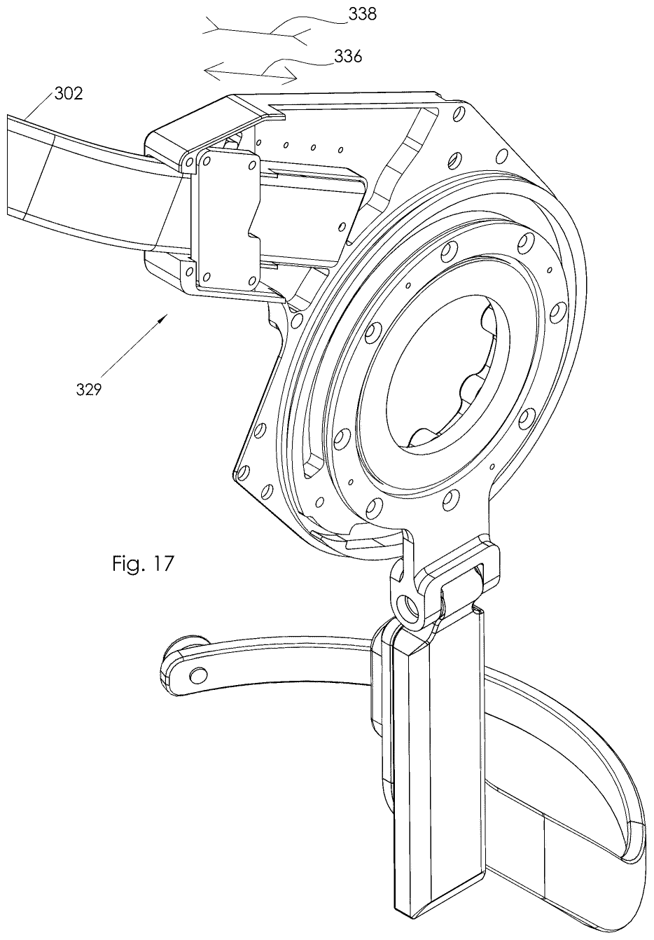

In some embodiments, lower frame part 302 is adjustable in width to fit various people. In some embodiments, supporting trunk frame 102 includes an adjustment mechanism 255 (shown in FIG. 16) to adjust a width of lower frame part 302. For example, in some embodiments, adjustment mechanism 255 can increase or decrease a width of lower frame part 302 as shown by arrows 332 and 334 in FIG. 16.

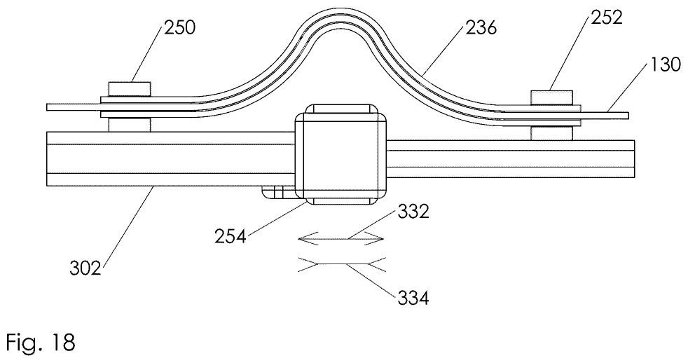

In some embodiments, lower frame part 302 is adjustable in depth to fit various people. In some embodiments, supporting trunk frame 102 includes an adjustment mechanism 329 (shown in FIG. 17) to adjust a depth of lower frame part 302. For example, in some embodiments, adjustment mechanism 329 can increase or decrease a depth of lower frame part 302 as shown by arrows 336 and 338 in FIG. 17.

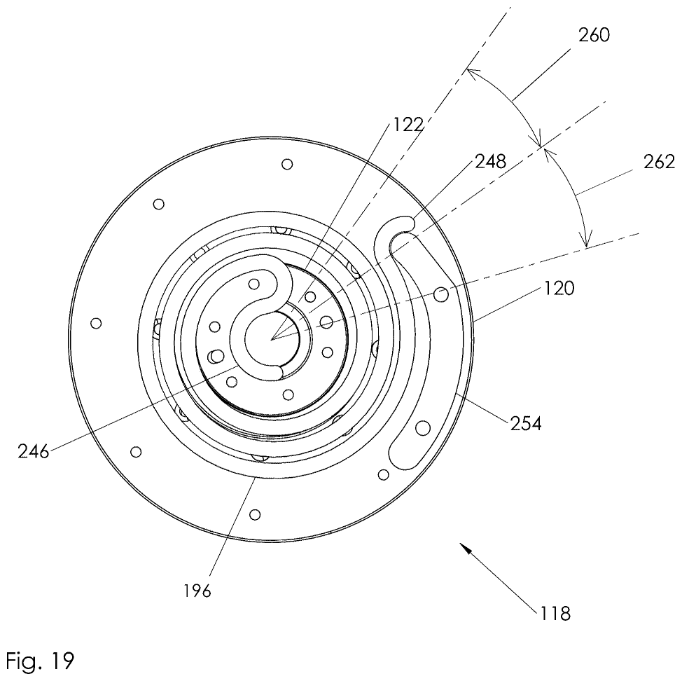

As mentioned, in some embodiments, supporting trunk frame 102 can be adjustable in width, length and depth to fit various wearers. In some such embodiments, and as shown in FIGS. 16 and 18, a shaft line jacket 236 encloses shaft line 130 and is secured to supporting trunk frame 102 at locations 250 and 252. This arrangement can help facilitate size adjustment of supporting trunk frame 102 without needing to adjust the size of shaft line 130. Similarly, in some embodiments, a housing line jacket 238 encloses housing line 128 and is secured to supporting trunk frame 102. This arrangement can help facilitate size adjustment of supporting trunk frame 102 without need to adjust the size of housing line 128. FIG. 18 schematically shows how shaft line 130 can be framed by jacket 236.

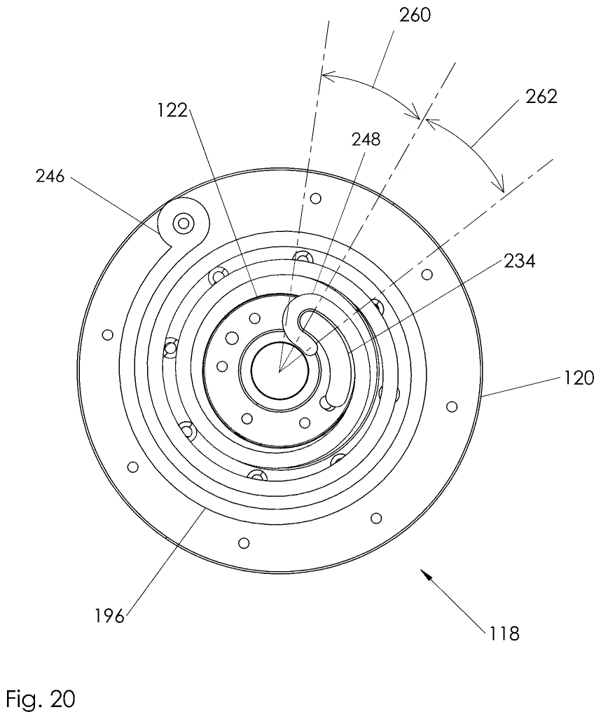

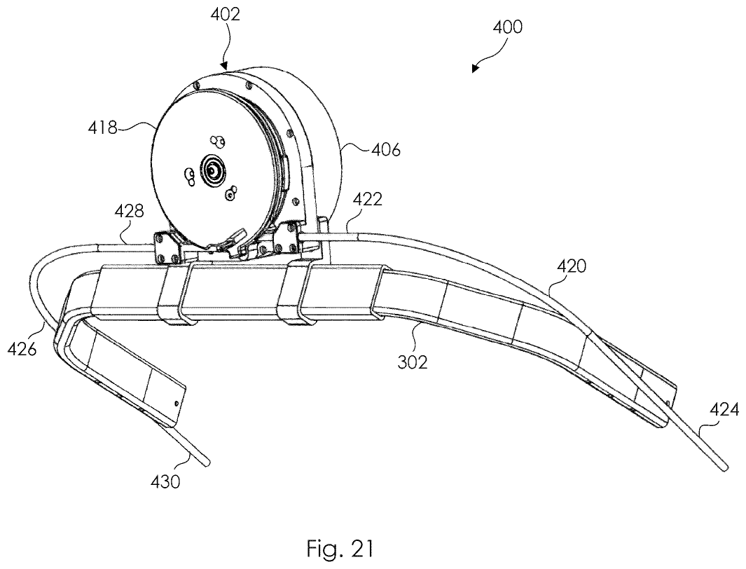

Additional aspects relating to actuator 118 will now be discussed with reference to FIGS. 19 and 20.

Actuator 118 can be or include any device or combination of devices capable of performing the indicated functions. Examples of actuator 118 include, electric motors, including, without limitation, AC (alternating current) motors, brush-type DC (direct current) motors, brushless DC motors, electronically commutated motors (ECMs), stepping motors, and combinations thereof. In some embodiments, actuator 118 comprises transmission systems such as harmonic drives, planetary gears, ball screw mechanism, lead screw mechanism, worm gear and combinations thereof. In some embodiments, actuator 118 comprises hydraulic actuators.

In some embodiments, actuator 118 includes an electric motor 116 configured to generate torque between actuator shaft 122 and actuator housing 120 by use of electric power. Electric motor 116 can be or include any device or combination of devices capable of performing the indicated functions. Examples of electric motor include, without limitation, an element or combination of elements selected from a group consisting of electric motors including, without limitation, AC (alternating current) motors, brush-type DC (direct current) motors, brushless DC motors, electronically commutated motors (ECMs), stepper motors, and combinations.

In some embodiments, actuator 118 includes a transmission system to alter and condition the torque of actuator 118. The transmission system can be or include any device or combination of devices capable of performing the indicated functions. Examples of transmission system include, without limitation, gear, worm gears, gear trains, pulleys, lines, belts, toothed belts, toothed pulleys, planetary gears, harmonic drives, spur gears, flexible belt, wire ropes, ropes, ball screw mechanisms, and lead screw mechanisms.

In some embodiments, as shown in FIGS. 19 and 20, actuator 118 includes an actuator spring 196 to generate resistive torque between actuator shaft 122 and actuator housing 120.

In some embodiments, actuator 118 includes both an electric motor 116 and an actuator spring 196 to generate resistive torque between actuator shaft 122 and actuator housing 120.

As shown in FIG. 19, actuator spring 196 can include a first end 246 and a second end 248. First end 246 of actuator spring 196 can be coupled, either directly or indirectly, to actuator shaft 122 such that when actuator shaft 122 turns relative to actuator housing (e.g., in response to wearer 200 bending in the sagittal plane), first end 246 of actuator spring 196 turns with actuator shaft 122.

When actuator shaft 122 is in a first range of rotation 260 of actuator shaft 122 relative to actuator housing 120, second end 248 of actuator spring 196 can be free. When actuator shaft 122 rotates relative to actuator housing 120 beyond the first range of rotation (e.g., by rotating in a clockwise direction relative to actuator housing 120), second end 248 of actuator spring 196 can become constrained by actuator housing 120. In other words, in this second range of rotation, second end 248 of actuator spring 196 can be coupled directly or indirectly to actuator housing 120 so that second end 248 of actuator spring 196 turns with actuator housing 120. When actuator shaft 122 is in this second range of rotation 262 in which second end 248 of spring 196 is constrained, further rotation of actuator shaft 122 relative to actuator housing 120 in the same direction (e.g., clockwise) can cause spring 196 to deflect and thereby cause spring 196 to provide a spring resistive torque on actuator shaft 122. In some embodiments, actuator housing 120 can include a housing protrusion 254 (shown in FIG. 19) to constrain second end 248 of actuator spring 196. As shown in FIG. 19, when actuator shaft 122 rotates relative to actuator housing 120 (e.g., in a clockwise direction), second end 248 becomes engaged with housing protrusion 254. After engagement of second end 248 with housing protrusion 254, second end 248 no longer rotates relative to actuator housing 120. Further rotation of actuator shaft 122 relative to actuator housing 120 in the same direction causes actuator spring 196 to flex and resist the rotation of actuator shaft 122 relative to actuator housing 120.

The configuration described above can allow for generation of the resistive torque not only by use of electric power, but also passively by use of actuator spring 196. In operation, when actuator shaft 122 is in the first range of rotation, electric motor 116 can generate resistive torque between actuator shaft 122 and actuator housing 120 by use electric power. When actuator shaft 122 is in the second range of rotation, actuator spring 196 can provide a spring resistive torque between actuator shaft 122 and actuator housing 120. In some embodiments, when actuator shaft 122 is in the second range of rotation, electric motor 116 can also provide a motor resistive torque on actuator shaft 122 relative to actuator housing 120. In such embodiments, the resistive torque is the addition of both spring torque and the torque generated by motor 116. The technique of adding an actuator spring torque in parallel with the electric motor torque discussed above is useful in increasing the torque capability of actuator 118.

Examples of actuator spring 196 include, without limitation, coil spring, rotary spring, leaf spring, helical spring, bungee cord, elastomer cord, clastic cord, elastic fabric cord, plastic cord, elastomer cord, twine, wire rope elastomer, string, and combinations thereof.

In the embodiment shown in FIG. 19, first end 246 of spring 196 is coupled to actuator shaft 122. However, in other embodiments, for example in the embodiment shown in FIG. 20, first end 246 end of spring 196 is instead coupled to actuator housing 120 such that when actuator housing 120 turns relative to actuator shaft 122 (e.g., in response to wearer 200 bending in the sagittal plane), first end 246 of actuator spring 196 turns with actuator housing 120. As shown in FIG. 20, when actuator housing 120 is in a first range of rotation 260 relative to actuator shaft 122, second end 248 of spring 196 can be free to rotate. When actuator housing 120 rotates relative to actuator shaft 122 (e.g., in a clockwise direction) beyond first range of rotation 260, second end 248 of spring 196 can become constrained (e.g., by a shaft constraining element 234 which is coupled to actuator shaft 122).

Based on the two embodiments of FIG. 19 and FIG. 20, it can be observed that, in general, spring 196 includes a first end 246 and a second end 248. First end 246 of spring 196 can be coupled to one of actuator shaft 122 or actuator housing 120. When actuator shaft 122 is in a first range of rotation relative to actuator housing 120, second end 248 of spring 196 can be free. Thus, when actuator shaft 122 is in the first range of rotation, spring 196 does not provide a spring resistive torque on actuator shaft 122. When actuator shaft 122 is in the second range of rotation relative to actuator housing 120, second end 248 of spring 196 can be constrained by the other one of actuator shaft 122 or actuator housing 120. In operation, when actuator shaft 122 is in the first range of rotation, motor 116 can provide a motor resistive torque on actuator shaft 122 relative to actuator housing 120. When actuator shaft 122 is in the second range of rotation, spring 196 can provide a spring resistive torque on actuator shaft 122 relative to actuator housing 120. In some embodiments, when actuator shaft 122 is in the second range of rotation, motor 116 can also provide a motor resistive torque on actuator shaft 122 relative to actuator housing 120.

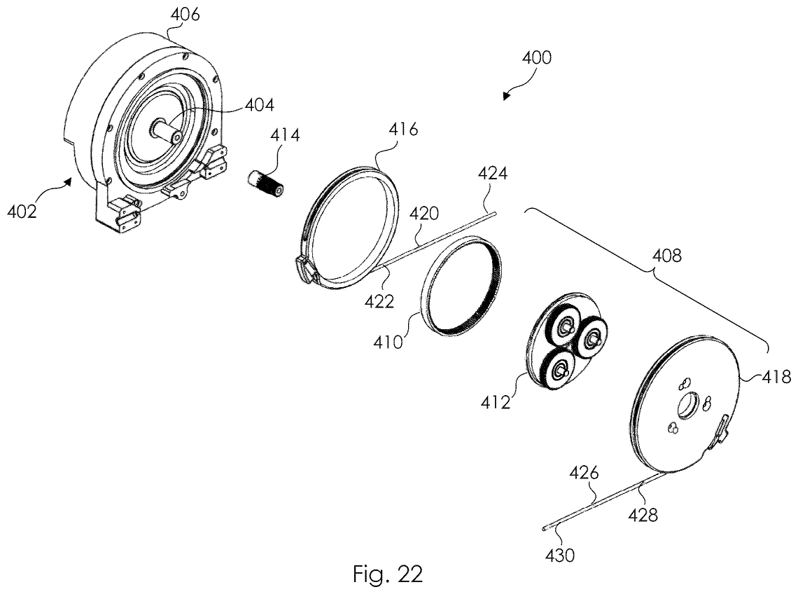

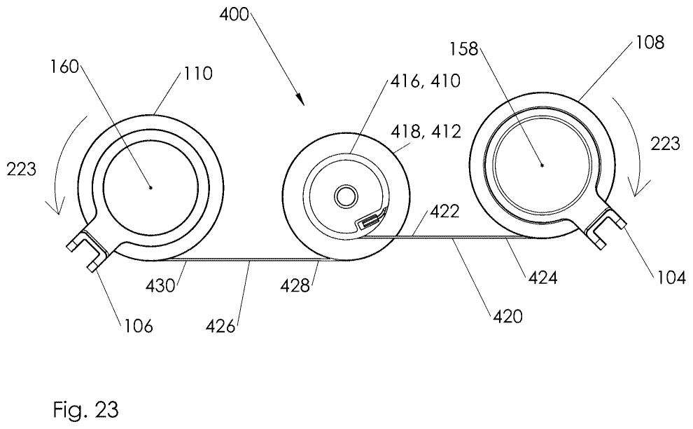

FIG. 21 and FIG. 22 show another embodiment of actuator 400 used to power trunk support exoskeleton 100. Actuator 400 comprises a motor 402. Motor 402 comprises a motor shaft 404 and a motor housing 406. Motor 402 is configured to generate a motor torque on motor shaft 404 relative to motor housing 406. Motor housing 406 is coupled to supporting trunk. As shown in FIG. 21, motor housing 406 is coupled to lower frame part 302. Actuator 400 additionally comprises a transmission, such as a planetary gear transmission 408. Planetary gear transmission 408 comprises a ring gear 410, a carrier gear 412 and a sun gear 414. Sun gear 414 is coupled to motor shaft 404 and therefore motor torque generates torques on ring gear 410 and carrier gear 412. As shown in FIG. 22, a ring gear pulley 416 is coupled to ring gear 410 and turns with ring gear 410. Similarly, a carrier pulley 418 is coupled to carrier gear 412 and turns with carrier gear 412.

A ring gear line 420 is used to transfer torque from ring gear pulley 416 to a first thigh link. Ring gear line 420 comprises a ring gear line first end 422 and a ring gear line second end 424. Ring gear line 420 is wound onto ring gear pulley 416 from ring gear line first end 422 and coupled to first thigh link from ring gear line second end 424. In this configuration, the actuator torque on ring gear 410 generates a tensile force in ring gear line 420. This tensile force provides an extension torque between first thigh link and supporting trunk.

A carrier line 426 is used to transfer torque from carrier pulley 418 to a second thigh link 106. Carrier line 426 comprises a carrier line first end 428 and a carrier line second end 430. Carrier line 426 is wound onto carrier pulley 418 from carrier line first end 428 and coupled to second thigh link 106 from carrier line second end 430. In this configuration, the torque on carrier gear 412 generates a tensile force in carrier line 426. The tensile force in carrier line 426 provides an extension torque between second thigh link 106 and supporting trunk.

In operation, when a wearer is in the bent forward position, motor 402 generates torques on carrier gear 412 and ring gear 410. This, in return, generates tensile forces in carrier line 426 and ring gear line 420. These tensile forces provide extension torques between first and second thigh links and supporting trunk thereby resisting the bending motion of supporting trunk.

In operation when the wearer is not in the forward bent position, motor 402 halts producing motor torque. This, in return, halts the production of any actuator torque on carrier gear 412 and the ring gear 410. Consequently, this results in a substantially free rotation between ring gear pulley 416 and carrier pulley 418. The free rotation of ring gear pulley 416 and carrier pulley 418 results in a substantially free movement of the thigh links relative to supporting trunk required for walking, climbing and ascending stairs and slopes.

In some embodiments, when wearer is not in the forward bent position, motor 402 generates a substantially small torque. This, in return, results in production of a substantially small actuator torques on carrier gear 412 and ring gear 410. The small actuator torques allows the first and second thigh links to move with little resistance relative to supporting trunk during walking, climbing and ascending stairs and slopes.

In some embodiments, when the first and second thigh links are in the reciprocating mode required for walking, climbing and descending stairs and slopes, motor 402 generates substantially small actuator torques on ring gear 410 and carrier gear 412. The small torques on ring gear 410 and carrier gear 412 results in a small resistance for movement of thigh links 104 and 106 relative to supporting trunk 102 during walking, climbing and ascending stairs and slopes.

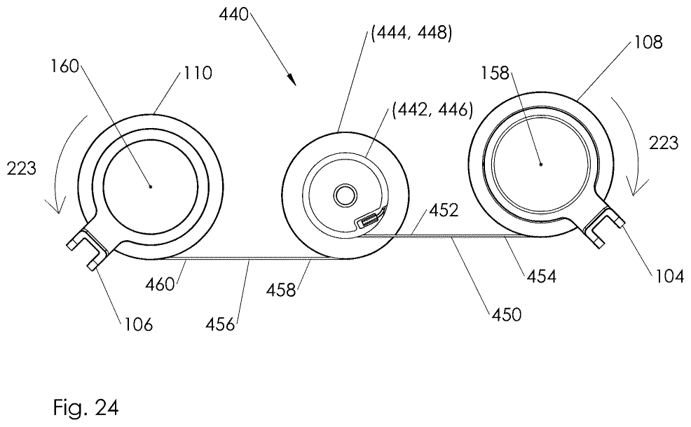

FIG. 23 schematically shows the arrangement illustrating how tensile forces from ring gear line 420 and carrier line 426 are transmitted to first and second thigh links 104 and 106. The entire mechanism that transfers torque to thigh links 104 and 106 is flattened into a two-dimensional schematic to clearly show the torque transfer method. One of ordinary skill in the art can design a variety of mechanisms to couple ring gear line 420 and carrier line 426 to first thigh link 104 and second thigh link 106 to generate torque between supporting trunk 102 and thigh links 104 and 106.

As shown in FIG. 23, in some embodiments, first thigh link 104 comprises a first thigh link pulley 108. First thigh link pulley 108 is coupled to thigh link 104 and rotates with first thigh link 104 about axis 158 relative to supporting trunk. Ring gear line 420 is wound on first thigh link pulley 108 from its second end 424 such that an actuator torque on ring gear 410 generates a tensile force in ring gear line 420. This tensile force generates an extension torque between first thigh link 104 and supporting trunk 102. Similarly, second thigh link 106 comprises a second thigh link pulley 110. Second thigh link pulley 110 is coupled to second thigh link 106 and rotates with second thigh link 106 about axis 160 relative to supporting trunk 102. Carrier line 426 is wound on second thigh link pulley 110 from its second end 430 such that an actuator torque on carrier gear 412 generates a tensile force in carrier line 426. This tensile force generates an extension torque between second thigh link 106 and supporting trunk 102. Ring gear pulley 416 and carrier pulley 418 are shown in FIG. 23 with different radius for clarity and easy visualization, although in the embodiment of FIG. 21 and FIG. 22 they have equal diameters. FIG. 23 essentially describes the basic principle of how torque can be transferred from actuator 400 to first thigh link pulley 108 and second thigh link pulley 110. Ring gear line 420 couples ring gear 410 to first thigh link pulley 108. Carrier line 426 couples carrier pulley 418 to second thigh link pulley 110. Both thigh links 104 and 106 can be moved to any arbitrary angles by wearer. As can be seen from FIG. 23, the tensile forces in carrier line 426 and ring gear line 420 provide extension torque along arrows 223.

In general, when a resisting torque is generated in actuator 400, tensile forces are produced in ring gear line 424 and carrier line 426. These tensile forces provide extension torques between thigh links (104 and 106) and supporting trunk 102 along arrows 223. Of course, in this embodiment, the angles of both thigh links 104 and 106 relative to supporting trunk 102 can change by wearer.

In some embodiments, ring gear line 420 and carrier line 426 each comprises an element or combination of elements selected from a group consisting of wire, cable, belts, fabric rope, plastic rope, cord, twine, chain, wire rope and string.

In some embodiments, motor 402 comprises an element or combination of elements selected from a group consisting of AC (alternating current) motors, brush-type DC (direct current) motors, brushless DC motors, electronically commutated motors (ECMs), stepper motors, and combinations thereof.

In some embodiments, motor 402 further comprises a transmission system. This transmission system comprises an item or combination of items selected from a group consisting of harmonic drives, planetary gears, ball screw mechanisms, lead screw mechanisms, worm gears and combinations thereof.

Similar to the embodiments of the invention shown in FIG. 2, a ring gear line jacket can be used to enclose ring gear line 420. This ring gear line jacket is secured to supporting trunk 102 to facilitate the size adjustment of the supporting trunk 102 without any adjustment to the size of ring gear line 420.

Similar to the embodiments of the invention shown in FIG. 2, a carrier line jacket can be used to enclosed carrier line 426. This carrier line jacket is secured to supporting trunk 102 to facilitate the size adjustment of supporting trunk 102 without any adjustment to the size of carrier line 426.

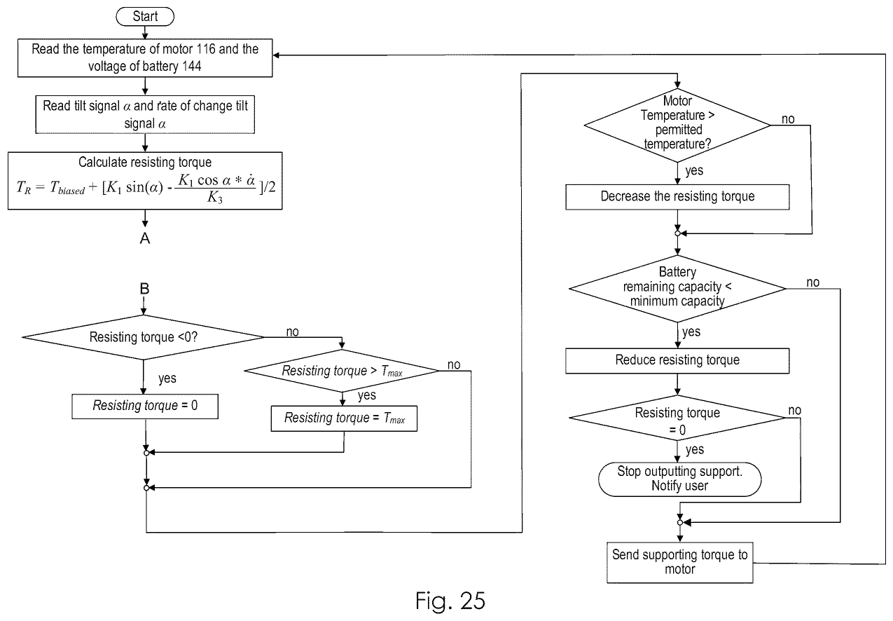

Both embodiments of actuator 118 shown in FIGS. 5-10 and actuator 400 shown in FIGS. 21 and 22 can be described more generally by encompassing all common characteristics through FIG. 24. FIG. 24 represents an actuator 440, which comprises an actuator first element 442 and an actuator second element 444. In some embodiments, actuator 440 is held on the rear side of supporting trunk 102. Additionally, actuator 440 is configured to generate actuator first torque and actuator second torque on actuator first element 442 and actuator second element 444 simultaneously.

Actuator first element 442 and actuator second element 444 are independently rotatable relative to each other. In other words, both actuator first element 442 and actuator second element 444 can be rotated relative to each other arbitrarily by external torques and forces. For example, if actuator first element 442 is turned 10 degrees with a particular speed trajectory, actuator second element 444 can simultaneously be rotated through any angle at any arbitrary speed trajectory without disturbing the motion of actuator first element 442. This is an important property of actuator 440 regardless of the value of the generated actuator first torque and the actuator second torque.

Actuator 440 further comprises an actuator first pulley 446, which is coupled to actuator first element 442 and turns with it. In some embodiments, both actuator first pulley 446 and actuator first element 442 are manufactured as one part. Additionally, actuator 440 comprises an actuator second pulley 448, which is coupled to actuator second element 444 and turns with it. In some embodiments, both actuator second pulley 448 and actuator second element 444 are manufactured as one part. In some embodiments, actuator first pulley 446 and actuator second pulley 448 have non-circular profiles.

A first line 450 is wound onto first actuator pulley 446 from its first end 452 and coupled to first thigh link 104 from its second end 454. This configuration allows an actuator first torque on actuator first element 442 to generate a tensile force in first line 450 thereby providing an extension torque between first thigh link 104 and supporting trunk 102.

A second line 456 is wound onto second pulley 448 from its first end 458 and coupled to second thigh link 106 from its second end 460. The actuator second torque of actuator second element 444 generates a tensile force in second line 456 thereby providing an extension torque between second thigh link 106 and supporting trunk 102.

In operation, when wearer is in the bent forward position, actuator 440 generates an actuator first torque on actuator first element 442 and an actuator second torque on actuator second element 444. These actuator torques generate tensile forces in first line 450 and second line 456. These tensile forces provide extension torques between first and second thigh links 104 and 106 and supporting trunk 102. The extension torque resists the bending motion of the supporting trunk 102. In this bent forward position, wearer 200 can still move her legs arbitrarily relative to her trunk. The person's legs are coupled to first and second thigh links 104 and 106 and arbitrary movements of the person's legs are permitted since both actuator first element 442 and actuator second element 444 can be rotated relative to each other arbitrarily.

In operation, when wearer is not in the forward bent position, actuator 440 halts producing any actuator torque on actuator first element 442 and actuator second element 444 resulting in a substantially free movement of actuator first pulley 446 and actuator second pulley 448 relative to each other. This consequently results in free movement of first thigh link 104 and second thigh link 106 relative to supporting trunk 102 facilitating the necessary motion for locomotion, walking, climbing and ascending stairs and slopes.

In some embodiments, when wearer is not in the forward bent position, actuator 440 generates a substantially small actuator first torque and a substantially small actuator second torque. These small actuator torques allow thigh links 104 and 106 move with little resistance relative to supporting trunk 102 during walking, climbing and ascending stairs and slopes.

In some embodiments, when thigh links 104 and 106 are in the reciprocating mode required for walking, climbing and descending stairs and slopes, actuator 440 generates a substantially small actuator first torque and actuator second torque. These small torques result in a small resistance for movement of thigh links 104 and 106 relative to supporting trunk 102 during walking, climbing and ascending stairs and slopes.

Actuator 118 shown in FIGS. 5-10 can be represented by actuator 440 in FIG. 24. Actuator housing 120 (shown in FIGS. 5-10) is represented by actuator second element 444 in FIG. 24. The actuator shaft 122 (shown in FIGS. 5-10) is represented by actuator first element 442. Actuator 440 is configured to generate an actuator first torque on actuator first element 442 (actuator housing 120) and actuator second torque on actuator second element 444 (actuator shaft 122). In this case, actuator first torque and actuator second torque are equal but in opposite directions to each other. Housing pulley 124 and shaft pulley 126 are represented by second pulley 448 and first pulley 446, respectively. In this case, actuator 440 (or actuator 118 in FIGS. 5-10) is floating but held by supporting trunk.

Actuator 400 shown in FIGS. 21-22 can be represented by actuator 440 in FIG. 24. Actuator 440 comprises motor 402. Motor 402 comprises a motor shaft 404 and a motor housing 406. Motor 402 is configured to generate torque on motor shaft 404 relative to motor housing 406. Actuator 440 further comprise a planetary gear transmission 408. Planetary gear transmission 408 comprises a ring gear 410, a carrier gear 412, and a sun gear 414, wherein sun gear 414 is coupled to motor shaft 404. The actuator first torque is generated on ring gear 410 and the actuator second torque is generated on carrier gear 412. In this embodiment, actuator first element 442 represents ring gear 410 and actuator second element 444 represents carrier gear 412. Ring pulley 416 and carrier pulley 418 are represented by first pulley 446 and second pulley 448. In the embodiments of FIGS. 21-22, unlike the embodiments shown in FIGS. 5-10, motor housing 406 is coupled to supporting trunk 102 and is stationary relative to supporting trunk 102.

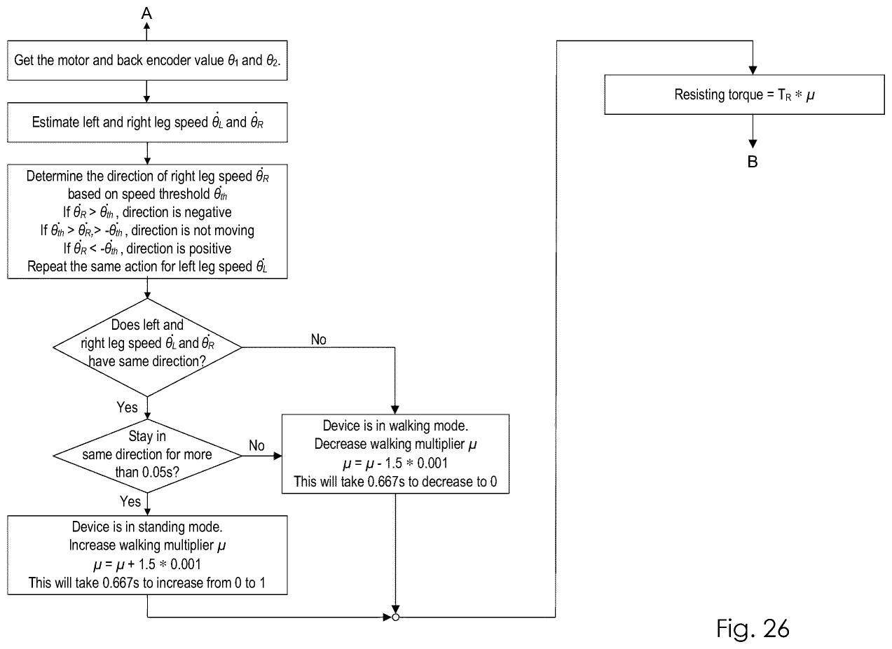

FIG. 25 illustrates another embodiment of a control algorithm. This algorithm is similar to the one shown in FIG. 15, and differs primarily in how the resisting torque is calculated. In certain embodiments, the first or second actuator torque can be calculated as follows:

$${T}_{R} = {T}_{biased} + [ {K}_{1} sin ( ∝ ) - \frac{{K}_{1} cos α}{{K}_{3}} \dot{∝} ] / 2 \qquad ( 9 )$$

wherein T_{R} is the resisting torque, T_{biased} is a biased extension torque, K₁ is a constant, K₁ is a constant, ∝ is a bending angle (tilt signal), and \dot{α} is the bending speed (rate of change of tilt signal) of the person.

In this new case, the resisting torque parameter K₂ (introduced in FIG. 15) has been replaced by K₁ cos α/K₃. In general, the resisting torque can take various forms to account for its dependency on bending speed \dot{∝}. Parameter K₁ is used to adjust the overall strength of the resisting torque, while K₃ controls how the resisting torque changes as a function of the bending speed \dot{α}.

In both control algorithms shown in FIGS. 15 and 25, parameters K₁, K₂ or K₃ can be adjusted. These adjustments can be made either through software or via knobs on the exoskeleton allowing the user to modify K₁, K₂ or K₃ for the desired behavior. For example, increasing K₁ will increase the resisting torque, while decreasing K₁ will reduce resisting torque. By adjusting K₂ or K₃, one can control how the resisting torque responds to the bending speed \dot{α}. These adjustments to K₂ or K₃ can also be made either through software or by the operator using knobs on the exoskeleton. In some embodiments, the controller features knobs that allow the operator to adjust the strength of the resisting torque, as well as its response to bending speed.

Note that in the actuator of the embodiment shown in FIGS. 5-10, both actuator housing 120 and actuator shaft 122 produce equal torque values. However, in the embodiments of the actuators shown in FIGS. 21-23, the torques on ring gear 410 and carrier gear 412 differ from each other. This inequality can be compensated for by adjusting the diameter of first thigh link pulley 108, second thigh link pulley 110, ring gear pulley 416 or carrier pulley 418.

Similarly, in the general form shown in FIG. 24, actuator first element 442 and actuator second element 444 might produce unequal torque values. This inequality can be compensated for by adjusting the size of first thigh link pulley 108, second thigh link pulley 110, first pulley 446 and second pulley 448.

In some embodiments, the controller sends a signal to the actuator to generate the first actuator torque or the second actuator torque, according to equation 9, when the wearer bends forward relative to the vertical gravitational line.

As seen in equation (9), when the bending angle α is small, both the first and second actuator torques are also small. In certain embodiments, the first and second actuator torques are functions of how much the wearer is bent forward relative to the vertical gravitational line. As shown by equation (9), this is reflected by sin(α). In these embodiments, the first and second actuator torques increase as the angle of the supporting trunk relative to the vertical gravitational line increases. In some embodiments, this relationship is represented by sin(α), which increases as a increases. In some embodiments, first and second actuator torques decrease as an angle of the supporting trunk frame relative to the vertical gravitational line decreases.

In some embodiments, a small amount of tensile force is applied in first line 450 and second line 456 by introducing a biased extension torque, T_{biased} as shown in equation (9). This creates a small initial tensile force in both first line 450 and second line 456.

In some embodiments, the controller sends a signal to the actuator to generate a substantially small first actuator torque and second actuator torque when the wearer is not bent forward relative to the vertical gravitational line. In some embodiments, controller 146 (see, e.g., FIGS. 1-2) stops sending a signal to actuator 440 to generate first actuator torque and second actuator torque when tilt signal indicates that wearer 200 is no longer bent forward in the sagittal plane. In some embodiments, controller 146 sends a signal to actuator 440 to generate a zero first actuator torque and zero second actuator torque when tilt signal indicates that wearer 200 is not bent forward in the sagittal plane.

In some embodiments, the trunk-supporting exoskeleton includes a tilt sensor that generates a tilt signal indicating the bending angle α of the supporting trunk frame relative to the vertical gravitational line in the sagittal plane. This tilt sensor may include an Inertial Measurement Units (IMUs), inclinometers, encoders, and angle sensors. In some embodiments, either the first or the second actuator torque is a function of the tilt signal.

In some embodiments, a controller signals the actuator to produce the first and second actuator torques when the wearer bends forward relative to the vertical gravitational line. When the wearer is not bent forward, the controller signals the actuator to generate minimal first and second actuator torques. Generally, the magnitude of these torques depends on the degree of forward bend. The first and second actuator torques increase as the supporting trunk's angle relative to the vertical gravitational line (i.e., bending angle α) increases and decreases as the bending angle decreases.

In some embodiments, the first and second actuator torques are functions of the angular velocity of the supporting trunk frame in the sagittal plane. The torques decrease as the forward bending angular velocity of the trunk increases, and the torques increase as this angular velocity decreases. Conversely, the first and second actuator torques increase as the unbending angular velocity of the trunk frame increases, and the first and second actuator torques decrease as this unbending angular velocity decreases.

The controller in FIG. 24 checks the remaining battery power, and not just its voltage. Various methods can be used to accomplish this. For example, by measuring the current drawn by the actuator and the battery voltage, and then integrating these values over time, the energy used during a specific time interval can be estimated. Subtracting this from the battery's stored energy provides an estimate of the remaining battery power.

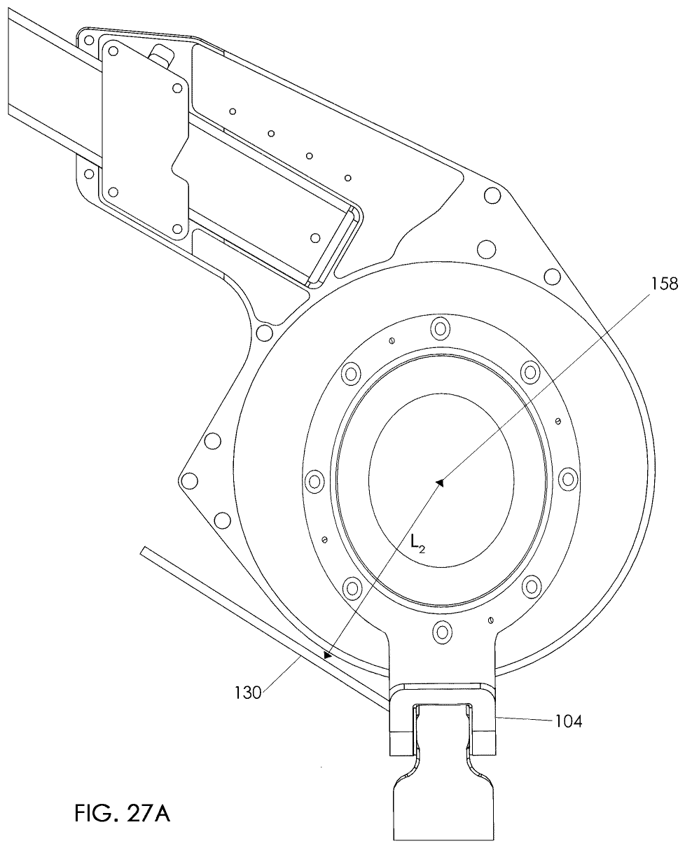

In some situations, such as when person 200 needs to bend and walk simultaneously, it is desirable to reduce the resisting torque, T_{R}. In this case one must first identify the situation that the operator is walking. In the embodiment of the controller, shown in FIG. 25, the controller enters into a state (shown by A) to examine if person 200 is walking. The details of the flowchart entering state A is shown in FIG. 26. As shown in FIG. 26, the velocity or speed of thigh links 104 and 106 are measured or estimated. After measuring or estimating the velocities of the thigh links (identified as \dot{θ}_{R} and \dot{θ}_{L}), the controller checks to identify if the velocities (speeds) are larger than a threshold velocity (\dot{θ}ₜₕ). The controller then examines if the velocities are in the same directions or are in the opposite directions to each other. If the velocities are not in the same directions, this means the person is walking. If the person is walking, the controller gradually reduces the resisting torque, T_{R} to a very small value or zero. This allows the operator to walk comfortably with little or no torque between supporting trunk 102 and the thigh links 104 and 106. This reduction of the resisting torque is done by calculating torque adjusting parameter μ which will be multiplied by T_{R} such that the torque sent to the actuator is equal to T_{R}*μ. When person 200 walks, torque adjusting parameter u reduces to a small value or zero after a short period of time. The reduction of the torque adjusting parameter μ can be done by a variety of equations. In some embodiments reducing parameter μ reduces linearly as a function of time as shown in FIG. 26 and in about 0.667 seconds reduces to zero. If the person is not walking, then torque adjusting parameter μ is increasing to 1. Again there are many forms of equations that can be used to increase torque adjusting parameter μ to 1. In some embodiments, the torque adjusting parameter μ increases or decreases as a function of time. In some embodiments, torque adjusting parameter μ increases or decreases as a function of angles θ_{R} and θ_{L} and velocities \dot{θ}_{R} and \dot{θ}_{L}. In some embodiments, torque adjusting parameter μ increases or decreases as a function of angle α or velocity \dot{α}.

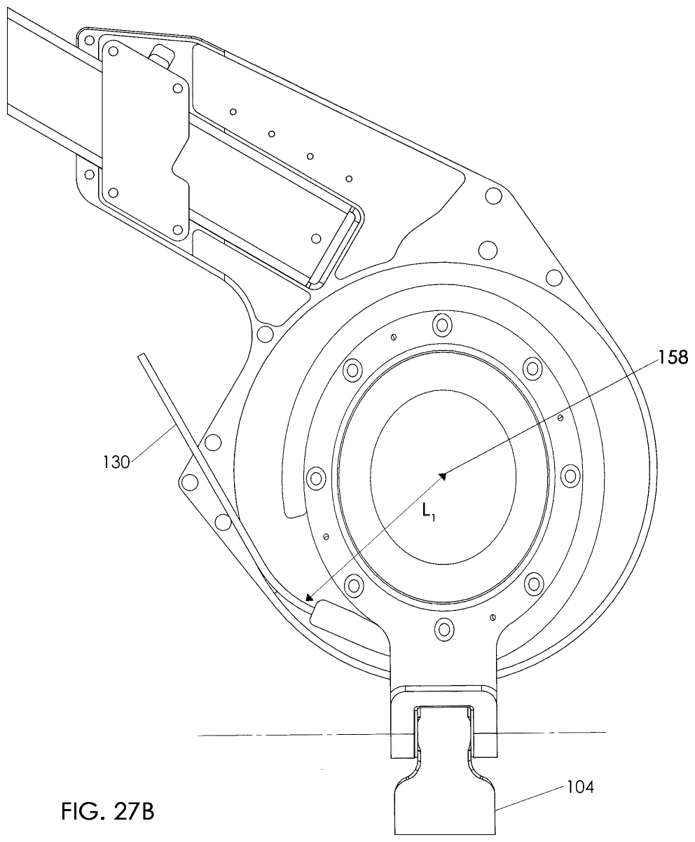

FIGS. 27A-B shows an embodiment, in which pulleys 108 and 110 have been replaced by non-circular type pulleys. In this embodiment, as the wearer bends forward, the moment arm of the tensile force in shaft line 130 affects the required torque from the actuator. As can be seen from FIGS. 27A-B, as the wearer bends forward (the angle between supporting trunk 102 and thigh link 104 get smaller, and the tensile force in shaft line 130 decreases. This means a smaller torque is required from the actuator when the wearer reaches his or her maximum bending angle. In other words, the torque requirement at large bending angle α decreases. A small required torque from the actuator results in a substantial decrease in heat generation in the actuator. For example, the increase of moment arm from L1 to L2 is 20%, the heat reduction will be about 40%.

1. A trunk supporting exoskeleton configured to be worn by a person to reduce the muscle forces in the person's back during forward lumbar flexion, the exoskeleton comprising:
a supporting trunk configured to be coupled to the person's trunk;
a first thigh link and a second thigh link each configured to be in contact with one of the person's thighs, wherein each of the first and second thigh links is rotatably coupled to the supporting trunk to allow for flexion and extension of respective first and second thigh links relative to the supporting trunk;
a motor comprising a motor shaft and a motor housing, wherein the motor housing is held by the supporting trunk, the motor is configured to generate a motor torque on the motor shaft relative to the motor housing;
a planetary gear transmission comprising a ring gear, a carrier gear, and a sun gear wherein the sun gear is coupled to the motor shaft and the motor torque generates an actuator torque between the ring gear and the carrier gear;
a ring gear pulley coupled to the ring gear and that turns with the ring gear;
a carrier pulley coupled to the carrier gear and that turns with the carrier gear;
a ring gear line comprising a ring gear line first end and a ring gear line second end, wherein the ring gear line is wound onto the ring gear pulley from the ring gear line first end and coupled to the first thigh link from the ring gear line second end such that the actuator torque between the carrier gear and the ring gear generates a tensile force in the ring gear line thereby providing an extension torque between the first thigh link and the supporting trunk; and
a carrier line comprising a carrier line first end and a carrier line second end, wherein the carrier line is wound onto the carrier pulley from the carrier line first end and coupled to the second thigh link from the carrier line second end such that the actuator torque between the ring gear and the carrier generates a tensile force in the carrier line thereby providing an extension torque between the second thigh link and the supporting trunk,
wherein when the person is in a forward bent position, the motor generates an actuator torque between the carrier gear and the ring gear to generate tensile forces in the carrier line and the ring gear line and to provide extension torques between the first and the second thigh links and the supporting trunk thereby resisting the bending motion of the supporting trunk.

2. The trunk supporting exoskeleton of claim 1, wherein:
the first thigh link comprises a first thigh link pulley and the second thigh link comprises a second thigh link pulley, wherein
the ring gear line is wound on the first thigh link pulley from the ring gear line second end such that the actuator torque between the ring gear and the carrier gear generates a tensile force in the ring gear line thereby providing an extension torque between the first thigh link and the supporting trunk, and
the carrier line is wound onto the second thigh pulley from the carrier line second end such that the actuator torque between the ring gear and the carrier gear generates a tensile force in the carrier line thereby providing an extension torque between the second thigh link and the supporting trunk.

3. The trunk support exoskeleton of claim 2, wherein first thigh link pulley and the second thigh link pulley each have a non-circular shape.

4. The trunk supporting exoskeleton of claim 1, wherein when the person is not in the forward bent position, the motor halts producing the actuator torque between the carrier gear and the ring gear resulting in a substantially free movement between the ring gear pulley and the carrier pulley and in a substantially free movement of the first and second thigh links relative to the supporting trunk during walking, ascending and descending stairs and slopes.

5. The trunk supporting exoskeleton of claim 1, wherein when the person is not in the forward bent position, the motor generates a substantially small actuator torque between the carrier gear and the ring gear resulting in a substantially small resistance for movement of the first and second thigh links relative to the supporting trunk during walking, ascending and descending stairs and slopes.

6. The trunk supporting exoskeleton of claim 1, wherein when the first and second thigh links are in a reciprocating mode for walking, the motor generates a substantially small torque between the ring gear and the carrier gear resulting in a substantially free movement of the first and second thigh links relative to the supporting trunk for walking.

7.-10. (canceled)

11. A trunk supporting exoskeleton configured to be worn by a person to reduce the muscle forces in the person's back during forward lumbar flexion, the exoskeleton comprising:
a supporting trunk configured to be coupled to the person's trunk;
a first thigh link and a second thigh link each configured to be in contact with one of the person's thighs, wherein each of the first and second thigh links is rotatably coupled to the supporting trunk to allow for flexion and extension of respective first and second thigh links relative to the supporting trunk;
an actuator comprising an actuator first element and an actuator second element, wherein:
the actuator is configured to concurrently generate a first actuator torque on the actuator first element and a second actuator torque on the actuator second element while the actuator first element and the actuator second element are configured to be rotatable independently of each other, and
the actuator first element and the actuator second element are coupled to the first thigh link and the second thigh link respectively such that arbitrary flexion and extension of the first and second thigh links relative to the supporting trunk rotate the actuator first element and the actuator second element respectively,
wherein:
when the person is in a forward bent position, the actuator generates the first actuator torque on the actuator first element and the second actuator torque on the actuator second element to generate extension torques between the first and the second thigh links and the supporting trunk thereby resisting the bending motion of the supporting trunk during the forward bent position.

12. The trunk supporting exoskeleton of claim 11, wherein when the person is not in a forward bent position, the actuator halts producing the first and the second actuator torques on the actuator first element and the actuator second element resulting in a substantially free movement of the actuator first element and the actuator second element and consequently free flexion and extension movements of the first thigh link and the second thigh link relative to the supporting trunk.

13. The trunk supporting exoskeleton of claim 11, wherein when the person is not in a forward bent position, the actuator generates a substantially small first actuator torque and second actuator torque resulting in a small resistance for movement of the first and second thigh links relative to the supporting trunk during walking, climbing and ascending stairs and slopes.

14. The trunk supporting exoskeleton of claim 11, wherein when the first and second thigh links are in a reciprocating mode for walking, the actuator generates no torque on the actuator first element and the actuator second element resulting in a substantially free rotation between the actuator first element and the actuator second element and substantially free rotation of the first and second thigh links relative to the supporting trunk for walking.

15. The trunk supporting exoskeleton of claim 11, wherein the actuator first element is coupled to the first thigh link via a first line and the actuator second element is coupled to the second thigh link via a second line.

16. (canceled)

17. The trunk supporting exoskeleton of claim 11, wherein:
an actuator first pulley coupled to the actuator first element and turns with the actuator first element;
an actuator second pulley coupled to the actuator second element and turns with the actuator second element;
a first line, wound onto the actuator first pulley from a first end of the first line and coupled to the first thigh link from a second end of the first line such that the first actuator torque generates a tensile force in the first line thereby providing an extension torque between the first thigh link and the supporting trunk, and
a second line wound onto the actuator second pulley from a first end of the second line and coupled to the second thigh link from a second end of the second line such that the second actuator torque generates a tensile force in the second line thereby providing an extension torque between the second thigh link and the supporting trunk.

18. (canceled)

19. The trunk supporting exoskeleton of claim 17, wherein:
the first thigh link comprises a first thigh link pulley and the second thigh link comprises a second thigh link pulley, wherein:
the first line is wound on the first thigh link pulley from the second end of the first line such that the actuator torque on the first actuator pulley generates a tensile force in the first line thereby providing an extension torque between the first thigh link and the supporting trunk, and
the second line is wound onto the second thigh pulley from the second end of the second line such that the second actuator torque generates a tensile force in the second line thereby providing an extension torque between the second thigh link and the supporting trunk.

20. The trunk support exoskeleton of claim 19, wherein first thigh link pulley and the second thigh link pulley each have a non-circular shape to reduce the tensile forces in the first line and the second line.

21. The trunk supporting exoskeleton of claim 11, wherein the actuator comprises a motor comprising a motor shaft and a motor housing, wherein the motor is configured to generate the first actuator torque on the motor shaft and the second actuator torque on the motor housing, and the actuator first element and the actuator second element are coupled to the motor shaft and the motor housing.

22.-24. (canceled)

25. The trunk supporting exoskeleton of claim 11, wherein the actuator comprises
a motor comprising a motor shaft and a motor housing, wherein the motor is configured to generate a torque on the motor shaft; and
a planetary gear transmission comprising a ring gear, a carrier gear, and a sun gear, wherein the sun gear is coupled to the motor shaft,
wherein the actuator first element is coupled to the ring gear and the actuator second element is coupled to the carrier gear.

26. (canceled)

27. The trunk supporting exoskeleton of claim 11, further comprising a controller configured to send a signal to the actuator to generate the first actuator torque and the second actuator torque when the person is bent forward relative to a vertical gravitational line.

28. The trunk supporting exoskeleton of claim 27, wherein the controller is configured to send a signal to the actuator to generate a substantially small first actuator torque and second actuator torque when the person is not bent forward relative to the vertical gravitational line.

29. The trunk supporting exoskeleton of claim 27, wherein the first actuator torque and the second actuator torque are based on an amount of forward bend of the person relative to the vertical gravitational line.

30. The trunk supporting exoskeleton of claim 27, wherein the first and the second actuator torques increase as an angle of the supporting trunk relative to the vertical gravitational line increases.

31. The trunk supporting exoskeleton of claim 27, wherein the first and second actuator torques decrease as an angle of the supporting trunk relative to the vertical gravitational line decreases.

32. The trunk supporting exoskeleton of claim 27, wherein the first and the second actuator torques are functions of an angular velocity of the supporting trunk in a sagittal plane.

33. The trunk supporting exoskeleton of claim 27, wherein the first and the second actuator torques decrease as a forward bending angular velocity of the supporting trunk in a sagittal plane increases.

34. The trunk supporting exoskeleton of claim 27, wherein the first and the second actuator torques increase as a forward bending angular velocity of the supporting trunk in a sagittal plane decreases.

35. The trunk supporting exoskeleton of claim 27, wherein the first and the second actuator torques increase as an unbending angular velocity of the supporting trunk in a sagittal plane increase.

36. The trunk supporting exoskeleton of claim 27, wherein the actuator torques decrease as an unbending angular velocity of the supporting trunk in a sagittal plane decreases.

37. The trunk supporting exoskeleton of claim 27, further comprising:
a tilt sensor that generates a tilt signal indicative of an angle of the supporting trunk relative to the vertical gravitational line in the sagittal plane, wherein one of the first actuator torque or the second actuator torque is based on the tilt signal.

38.-39. (canceled)
